(19) United States
(12) Patent Application Publication
(10) Pub. No.: US 2024/0181439 A1
(43) Pub. Date: Jun. 6, 2024

(54) POROUS SUBSTRATES COMPRISING PTFE COMPOSITIONS

(71) Applicant: Donaldson Company, Inc., Bloomington, MN (US)

(72) Inventors: Shane Lawson, Waconia, MN (US); Stephen K. Sontag, Plymouth, MN (US); Yehya A. Elsayed, Bloomington, MN (US); Anil Suthar, Eden Prairie, MN (US)

(21) Appl. No.: 18/527,047

(22) Filed: Dec. 1, 2023

Related U.S. Application Data
(60) Provisional application No. 63/429,959, filed on Dec. 2, 2022.

(51) Int. Cl. B01J 37/02; B01J 20/26; B01J 20/28; B01J 20/32; B01J 31/06; B01J 37/00

(52) U.S. Cl. CPC B01J 37/0219; B01J 20/261; B01J 20/28023; B01J 20/3295; B01J 31/06; B01J 37/0072; B01J 37/0236; B01J 35/657

(57) ABSTRACT

Porous substrates comprising a composition disposed thereon and methods of disposing a composition on porous substrates. The composition includes a matrix. The matrix includes a plurality of polytetrafluroethylene fibrils and a plurality of active particles.

### CROSS-REFERENCE TO RELATED APPLICATION

This application claims the benefit of U.S. Provisional Patent Application No. 63/429,959, filed Dec. 2, 2022, which is incorporated herein by reference in its entirety.

### BACKGROUND

Catalysts and sorbents (adsorbents and absorbents) can be used to remove unwanted chemicals from a fluid (e.g., a gas or a liquid). For example, catalysts can be used to destroy chemicals such as ozone or to synthesize desirable species from reactant feedstocks. Sorbents can be used to isolate or remove acidic molecules, basic molecules, ozone, or other various organic or inorganic compounds from fluids. Catalysts and sorbents may be difficult to handle when in a powdered or particulate form. As such, catalysts and sorbents are often secured onto a support. Securing a catalyst or sorbent onto a support may make the catalyst or sorbent easier to handle; however, securing the catalyst or sorbent to the support may reduce the surface area of the catalyst or sorbent available to remove the unwanted chemicals from the fluid. Additionally, the physical and chemical properties of the support may impact the functionality of the catalysts (e.g., catalytic efficiency) or adsorbent. Furthermore, the physical and chemical properties of the support may impact the ultimate configuration of a product (e.g., a filter) that includes a catalyst-or sorbent-functionalized support. Ideally, a catalyst- or adsorbent-functionalized support has one or more of the following characteristics: is readily shape engineered; has the catalyst or sorbent fixed in a configuration such as to display a large surface area of the catalyst or sorbent; and resists mechanical and chemical degradation.

### SUMMARY OF THE DISCLOSURE

The present disclosure provides a porous substrate having a composition disposed thereon. The composition includes a matrix that includes a plurality of PTFE fibrils and a plurality of active particles. In some embodiments, the plurality of PTFE fibrils comprises short-strand PTFE fibrils and long-strand PTFE fibrils. In some embodiments, the composition further includes free active particles, free PTFE fibrils, or both. In some embodiments, the plurality of active particles, the free active particles (if present), or both, comprise a catalyst, an adsorbent, a growth seed, a metal-organic framework (MOF), or combinations thereof.

In some embodiments, the porous substrate comprises a major surface and a plurality of macro pores coupled to the major surface. In some such embodiments, a first portion of the composition is disposed on at least a portion of the major surface and at least a portion of the plurality of macro pores are impregnated with a second portion of the composition. In some embodiments, the porous substrate further comprises a third portion of the composition embedded within the porous substrate.

Methods for disposing a composition on a porous substrate to result in the porous substrate of any one of the preceding embodiments are disclosed.

The terms “short-strand PTFE fibril” and “long-strand PTFE fibril” are used relative to one another. A short-strand PTFE fibril has a length that is shorter than a long-strand PTFE fibril as measure per the Dimensional Analysis Test Method. A plurality of short-strand PTFE fibrils has an average length that is shorter than the average length of a plurality of long-strand PTFE fibrils as measure per the Dimensional Analysis Test Method. The length of a fibril is the largest dimension of the fibril. Short-strand PTFE fibrils and long-strand PTFE fibrils are formed from PTFE starting materials having different average PTFE resins sizes.

As used herein, the term “active particle” refers to a particle that includes at least one component that is capable of participating in a chemical reaction (e.g., as a catalyst) and/or is capable as acting as an adsorbent and/or absorbent.

Herein, the term “comprises” and variations thereof do not have a limiting meaning where these terms appear in the description and claims. Such terms will be understood to imply the inclusion of a stated step or element, or group of steps or elements, but not the exclusion of any other step or element, or group of steps or elements. The phrase “consisting of” means including, and limited to, whatever follows the phrase “consisting of.” Thus, the phrase “consisting of” indicates that the listed elements are required or mandatory, and that no other elements may be present. The phrase “consisting essentially of” means including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may, or may not, be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

Herein, “up to” a number (e.g., up to 50) includes the number (e.g., 50). Herein, “at least” a number (e.g., at least 50) includes the number (e.g., 50). Herein, “no more than” a number (e.g., no more than 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” or “ambient temperature” refers to a temperature of 20° C. to 25° C.

The term “in the range” or “within a range” (and similar statements) includes the endpoints of the stated range.

Reference throughout this specification to “one aspect,” “an aspect,” “aspects,” “one embodiment,” “an embodiment,” “certain embodiments,” “some embodiments,” or “one or more embodiments” etc., means that a particular feature, configuration, composition, or characteristic described in connection with the embodiment or aspect is included in at least one embodiment or aspect of the disclosure. Thus, the appearances of such phrases in various places throughout this specification are not necessarily referring to the same embodiment or aspect of the disclosure. Furthermore, the particular features, configurations, compositions, or characteristics may be combined in any suitable manner in one or more embodiments or aspects.

The term “on” when used in the context of a composition or a hydrated solid disposed on a surface or a substrate, includes both the composition or the hydrated solid directly or indirectly (e.g., on a primer layer) disposed on (e.g., applied to) the surface or a substrate. Thus, for example, a composition or a hydrated solid disposed on a pre-treatment layer or a primer layer overlying a substrate constitutes a composition or a hydrated solid disposed on the substrate.

The above summary of the present disclosure is not intended to describe each disclosed embodiment or every implementation of the present disclosure. The description that follows more particularly exemplifies illustrative embodiments. In several places throughout the disclosure, guidance is provided through lists of examples, which examples may be used in various combinations. In each instance, the recited list serves only as a representative group and should not be interpreted as an exclusive or exhaustive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

The complete disclosure of all patents, patent applications, and publications, and electronically available material cited herein are incorporated by reference in their entirety. In the event that any inconsistency exists between the present disclosure and the disclosure(s) of any document incorporated herein by reference, the present disclosure shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

### BRIEF DESCRIPTION OF THE FIGURES

FIG. 1 is a schematic representation of an illustrative matrix at two magnification powers.

FIG. 2A is a schematic representation of a short-strand PTFE fibril.

FIG. 2B is a schematic representation of a long-strand PTFE fibril.

FIG. 3A is a schematic representation of a catenation structure of a plurality of active particles around a fibril of the matrix of FIG. 1.

FIG. 3B is a schematic representation of a conglomerated structure that includes a portion of the plurality of active particles and a portion of the plurality of fibrils of the matrix of FIG. 1.

FIG. 4 is a schematic representation of a porous substrate having a composition and/or one or more components of the composition disposed thereon and impregnated within.

FIG. 5 is a schematic representation of embedment of particles within the solid portion of a porous substrate.

FIG. 6 is a flow diagram outlining a first method of making a composition and/or a method of coating a substrate with a composition, the methods consistent with embodiments of the present disclosure.

FIG. 7 is a flow diagram outlining a second method of making a composition and/or a method of coating a substrate with a composition, the methods consistent with embodiments of the present disclosure.

FIG. 8 is a flow diagram outlining a method for drying a hydrated composition to form a matrix, the method consistent with embodiments of the present disclosure.

FIG. 9 is a first scanning electron micrograph of a matrix consistent with the present disclosure. The matrix included 40 wt-% K₂CO₃, 8.6 wt-% PTFE-12, and 51.4 wt-% PTFE-E. Image information: working distance (WD)=4.0 mm; 5.0 kV LED; ×11,000.

FIG. 10 is a second scanning electron micrograph of a matrix consistent with the present disclosure. The matrix included 68.9 wt-% CARULITE, 15.5 wt-% PTFE-E, and 15.5 wt-% PTFE-12. Image information: WD=4.9 mm; 5.0 kV LED; ×370.

FIG. 11 is a third scanning electron micrograph of a matrix consistent with the present disclosure. The matrix included 68.9 wt-% CARULITE, 15.5 wt-% PTFE-E, and 15.5 wt-% PTFE-12. Image information: WD=7.2 mm; 5.0 kV LED; ×3,500.

FIG. 12 is a fourth scanning electron micrograph of a matrix consistent with the present disclosure. The matrix included 68.9 wt-% CARULITE, 15.5 wt-% PTFE-E, and 15.5 wt-% PTFE-12. Image information: WD=7.5 mm; 5.0 kV LED; ×1,100.

FIGS. 13A and 13B show electron micrographs of the surface coatings of a polyurethane substrate that has a composition comprising K₂CO₃ particles, CSAC particles, long-strand PTFE fibrils, and short-strand PTFE fibrils after precipitation under vacuum. Image information for FIG. 13A: WD=4.8 mm; 5.0 kV LED; ×130. Image information for FIG. 13B: WD=3.9 mm; 5.0 kV LED; ×2300.

FIGS. 14A and 14B show cross-sectional SEM images of the polyurethane substrate of FIGS. 13A and 13B. Image information for FIG. 14A: WD=3.4 mm; 5.0 kV LED; ×170. Image information for FIG. 14B: WD=3.4 mm; 5.0 kV LED; ×8000.

FIG. 15 is a plot showing H₂S breakthrough performance across the substrate of FIG. 16 and FIG. 17 at 25° C., 100-300 cm³/min, and 25 ppm.

FIGS. 16A and 16B show images of the major surfaces of PU-15 substrates that were exposed to a method for disposing a composition thereon that did not (FIG. 16A) and did (FIG. 16B) include treatment with an ethanol bath.

FIGS. 17A and 17B show electron micrographs comparing the surfaces of PU-15 substrates having a composition disposed thereon where the method did not (FIG. 17A) and did (FIG. 17B) include the use of ethanol as a wetting agent. Image information for FIG. 17A: WD=4.2 mm; 5.0 kV LED; ×4,300. Image information for FIG. 17B: WD=6.4 mm; 5.0 kV LED; ×19,000.

FIGS. 18A, 18B, 18C, and 18D compare the surface integrities of a polyurethane substrate having a composition that included K₂CO₃/CSAC only PTFE-E (FIGS. 18A-18B) or both PTFE-E/PTFE-12 (FIGS. 18C-18D) disposed thereon. Image information for FIG. 18A: WD=5.9 mm; 5.0 kV LED; ×190. Image information for FIG. 18B: WD=6.7 mm; 5.0 kV LED; ×11,000. Image information for FIG. 18C: WD=6.6 mm; 5.0 kV LED; ×37. Image information for FIG. 18D: WD=6.4 mm; 5.0 kV LED; ×6,000.

### DETAILED DESCRIPTION OF ILLUSTRATIVE EMBODIMENTS

The present disclosure provides porous substrates having a composition disposed thereon and methods of disposing such compositions on such substrates. The compositions of the present disclosure include a matrix that includes a plurality of PTFE fibrils and a plurality of active particles. In some embodiments, the compositions may further include free active particles, free PTFE fibrils, or both.

Disposing a composition on a porous substrate includes disposing such composition on a major surface of the substrate; impregnating the substrate with such composition or one or more components of the composition (e.g., a free active particle, a free PTFE fibril, a matrix, or any combination thereof); embedding such composition or one or more components within the substrate; or any combination thereof. As such, porous substrates of the present disclosure may have the composition disposed on at least a portion of a major surface; may be impregnated with the composition and/or one or more of the composition components; may have composition and/or one or more components embedded within; or any combination thereof.

### Compositions

The compositions of the present disclosure include a matrix. Matrices of the present disclosure include a plurality of PTFE fibrils and a plurality of active particles. In some embodiments, the compositions may further include free active particles, free PTFE fibrils, or both.

### Plurality of Polytetrafluoroethylene (PTFE) Fibrils

The compositions of the present disclosure include a matrix. Matrices of the present disclosure include a plurality of PTFE fibrils. A fibril may include a single strand of PTFE or multiple strands of PTFE. In some embodiments, the fibrils are arranged in a fiber configuration; that is, a plurality of ordered PTFE strands generally arranged in the same direction.

The PTFE fibrils are formed from PTFE resin. PTFE resin may include PTFE polymers, oligomers, monomers, or any combination thereof. PTFE resin may be a solid or a liquid. The PTFE resin may be in an emulsion. The PTFE resin includes particles that include the PTFE polymers, oligomers, monomers, or any combination thereof. Each particle of the PTFE resin has a resin particle size. The resin particle size is defined as the greatest distance across a resin particle.

In some embodiments, the plurality of PTFE fibrils are a single species of PTFE fibrils, such as short-strand PTFE fibrils or long-strand PTFE fibrils. In some embodiments, the matrices of the present disclosure include short-strand PTFE fibrils (formed from short-strand PTFE resin) and long-strand PTFE fibrils (formed from long-strand PTFE resin).

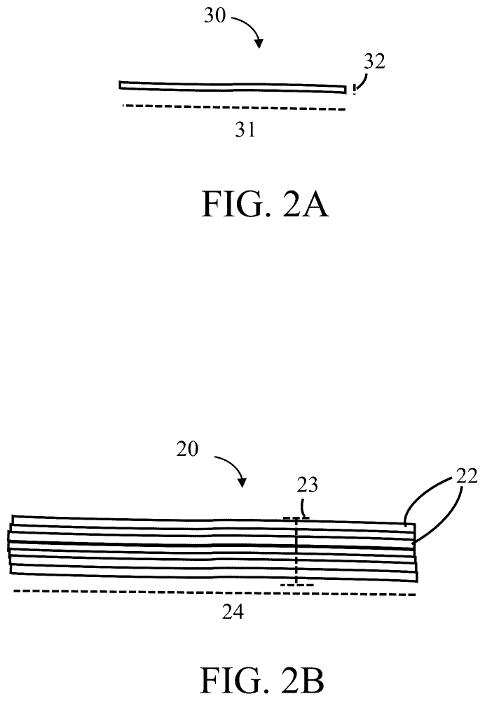

FIG. 2A shows a schematic representation of a short-strand PTFE fibril 30. The short-strand PTFE fibril has a length 31 and a diameter 32. The length of a PTFE fibril (short-strand or long-strand) is the distance spanning the largest dimension of the fibril The diameter of a PTFE fibril (short-strand or long-strand) is the greatest distance spanning the smallest dimension of the fibril.

Short-strand PTFE fibrils are formed from short-strand PTFE resin. Short-strand PTFE resin may be obtained or formed as an emulsion with a dispersant (e.g., water and/or an organic solvent) and/or a surfactant. As used herein, the use of short-strand PTFE resin includes the use of resin and/or the use of a short-strand PTFE emulsion with a dispersant and/or a surfactant. In some embodiments, short-strand PTFE resin, such as the PTFE resin used to form the short-strand PTFE fibrils of the matrices of the present disclosure, has an average resin particle size of 1 μm to 9 μm, preferably 3 μm to 5 μm as measured according to the Dimensional Analysis Test Method. Upon incorporation of the short-strand PTFE resin into the matrices of the present disclosure (e.g., using the methods of the present disclosure), the resin particles of the short-strand PTFE resin lengthen (e.g., fibrilizes) to form the short-strand PTFE fibrils.

In some embodiments, the short-strand PTFE fibrils of the matrices have an average length of 30 μm or less (down to 1 μm), preferably 20 μm or less (down to 1 μm), 10 μm or less (down to 1 μm), or 5 μm or less (down to 1 μm) as measured according to the Dimensional Analysis Test Method. In embodiments, the short-strand PTFE fibrils of the matrices have an average length of 30 μm or less (down to 1 μm), preferably 20 μm or less (down to 1 μm), 10 μm or less (down to 1 μm), or 5 μm or less (down to 1 μm) as measured according to the Dimensional Analysis Test Method. In some embodiments, the short-strand PTFE fibrils of the matrices have an average diameter of 0.01 μm or greater, 0.05 μm or greater, 0.3 μm or greater, or 0.5 μm or greater as measured according to the Dimensional Analysis Test Method. In some embodiments, the short-strand PTFE fibrils the matrices have an average diameter of 1 μm or less, 0.5 μm or less, or 0.3 μm or less as measured according to the Dimensional Analysis Test Method.

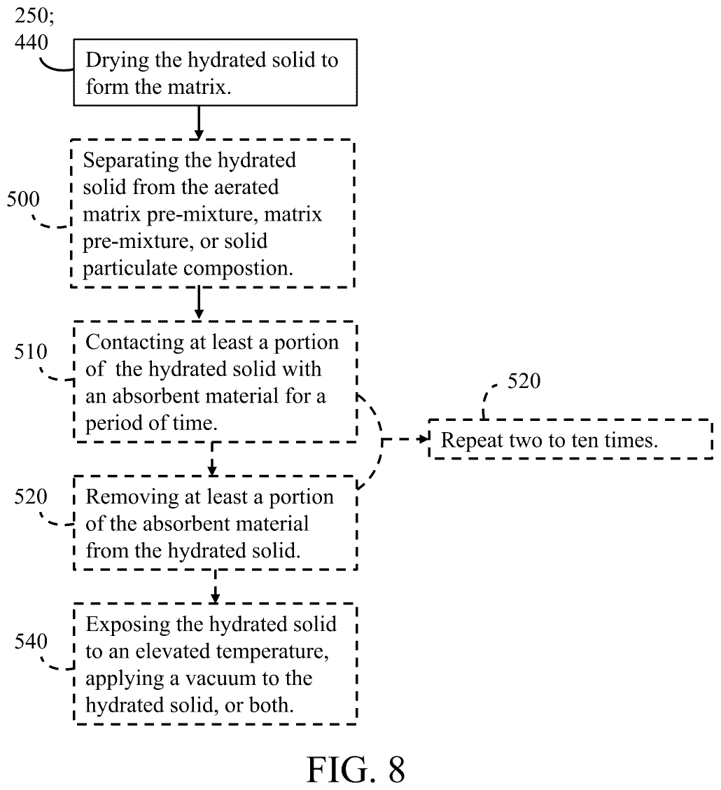

The short-strand PTFE fibrils of the matrices are generally not arranged in an ordered fashion (e.g., see FIG. 8 and discussion elsewhere herein).

FIG. 2B shows a schematic representation of a long-strand PTFE fibril 20. The long-strand PTFE fibril 20 has a diameter 23 and a length 24. In some embodiments, the long-strand PTFE fibril 20 is made up of a plurality of component PTFE fibrils 22. The plurality of component PTFE fibrils 22 are generally aligned in the same direction forming the long-strand PTFE fibril structure. As such, a long-strand PTFE fibril may be thought of as a fiber in that it is made up of component fibrils generally aligned in a singular direction. The plurality of component PTFE fibrils 22 are distinct from short-strand PTFE fibrils for at least the reason that the component PTFE fibrils 22 have an average length that is longer than the short-strand PTFE fibrils. In some embodiments, the long-strand PTFE fibrils (and therefore the component PTFE fibrils) have an average length of 40 μm or greater, 100 μm or greater, 150 μm or greater, 250 μm or greater, 500 μm, 700 or μm or greater, 1000 μm or greater as measured according to the Dimensional Analysis Test Method. In some embodiments, the long-strand PTFE fibrils have an average length of 2000 μm or less, 1000 μm or less, 700 μm or less, 500 μm or less, 250 μm or less, 150 μm or less, or 100 μm or less as measured according to the Dimensional Analysis Test Method. The plurality of component PTFE fibrils 22 do not need to be directly interacting; that is, there may be a space separating two or more of the component PTFE fibrils. Each one of the component PTFE fibrils of the plurality of component PTFE fibrils 22 has a diameter that is thinner than the diameter of the long-strand PTFE fibril 20. The diameter 23 of the long-strand PTFE fibril is the sum of the thickness of each component PTFE fibril and the space (if any) between the component PTFE fibrils. In some embodiments, the average diameter of the long-strand PTFE fibrils is 0.5 μm or greater, 1 μm or greater, 10 μm or greater, or 50 μm or greater. In some embodiments, the average diameter of the long-strand PTFE fibrils is 100 μm or less, 50 μm or less, 10 μm or less, or 1 μm or less as measured according to the Dimensional Analysis Test Method. In some embodiments, the average diameter of the long-strand PTFE fibrils is 0.5 μm to 50 μm, preferably 1 μm to 50 μm, and more preferably 10 μm to 50 μm as measured according to the Dimensional Analysis Test Method.

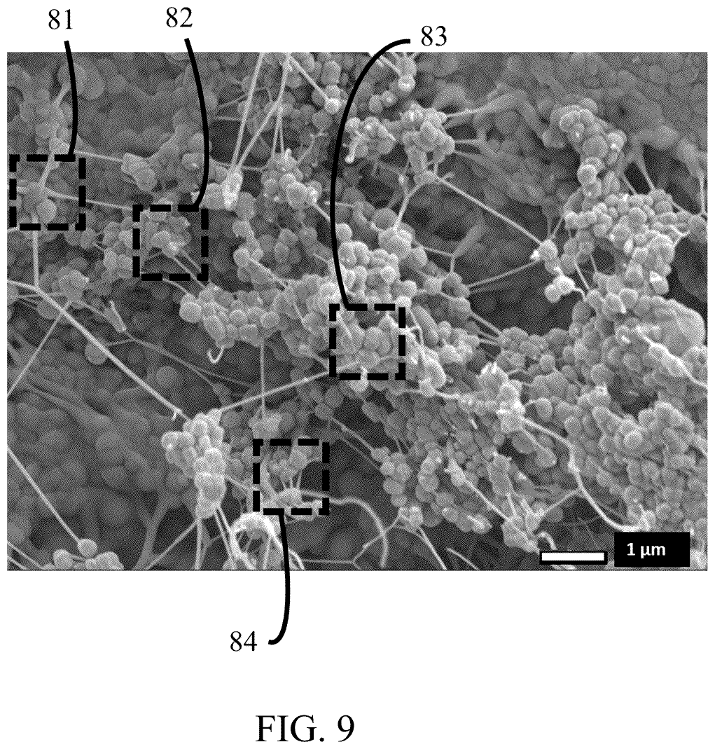

Long-strand PTFE fibrils are formed from long-strand PTFE resin. In some embodiments, the long-strand PTFE resin has an average resin particle size of 10 μm or greater, 25 μm or greater, 50 μm or greater, 100 μm or greater, 200 μm or greater, 200 μm or greater, and up to 1000 μm as measured according to the Dimensional Analysis Test Method. Upon incorporation of the long-strand PTFE resin into the matrices of the present disclosure (e.g., using the methods of the present disclosure), the particles of the long-strand PTFE resin lengthen (e.g., fibrilizes) to form the long-strand PTFE fibrils. An example of a portion of long-strand PTFE fibril in a matrix of the present disclosure is shown in FIG. 9 in box 30. Without wishing to be bound by theory, it is thought that the long-strand PTFE fibrils may impart some degree of mechanical rigidity to the matrix resulting in a matrix that is membrane-like.

Without wishing to be bound by theory, it is thought that the particles of the short-strand PTFE resin and particles of the long-strand PTFE resin do not merge to form PTFE fibrils; that is, it is thought that particles of the long-strand PTFE resin forms long-strand PTFE fibrils and the particles of the short-strand PTFE resin forms short-strand PTFE fibrils. A short-strand PTFE fibril may be located within a long-strand PTFE fibril; however, they are thought to be separate entities.

The average diameter of the PTFE fibrils, the average length of the PTFE fibrils, and the average resin particle size may be determined using various methods including microscopy, such as scanning electron microscopy (SEM; see the Dimensional Analysis Test Method) or transmission electron microscopy (TEM).

In some embodiments, the compositions and/or matrices of the present disclosure include 5 weight-% (wt-%) or greater, 15 wt-% or greater, 25 wt-% or greater, 45 wt-% or greater, 55 wt-% or greater, 65 wt-% or greater, or 80 wt-% or greater of the plurality of PTFE fibrils based on the total weight of the composition and calculated according to the Composition Analysis Test Method. In some embodiments, the composition comprises 95 wt-% or less, 80 wt-% or less, 65 wt-% or less, 55 wt-% or less, 45 wt-% or less, 25 wt-% or less, or 15 wt-% or less of the plurality of PTFE fibrils based on the total weight of the composition and calculated according to the Composition Analysis Test Method.

The ratio of short-strand PTFE fibrils to long-strand PTFE fibrils in the composition may vary depending on the desired end application of the composition. The ratio and weight percentages of short-strand PTFE fibrils and long-strand PTFE fibrils in the composition are defined as the mass of short-strand PTFE resin and the mass of long-strand PTFE resin used to make the matrix. In some embodiments, the ratio by weight of short-strand PTFE fibrils to long-strand PTFE fibrils may be 5 parts to 1 part short-strand PTFE fibrils for every 0.1 part long-strand PTFE fibrils, preferably 3 parts to 1 part short-strand PTFE fibrils for every 0.1 part long-strand PTFE fibrils.

Stated differently, the total amount of PTFE (i.e., the sum of the short-strand PTFE fibrils and long-strand PTFE fibrils) in the matrix may include varying weight percentages of short-strand PTFE fibrils and long-strand PTFE fibrils. In some embodiments, the composition includes 0.1 wt-% or greater, 1 wt-% or greater, 5 wt-% or greater, 15 wt-% or greater, 25 wt-% or greater, 45 wt-% or greater, 55 wt-% or greater, 65 wt-% or greater, or 80 wt-% or greater of short-strand PTFE fibrils based on the total weight of the composition and calculated according to the Composition Analysis Test Method. In some embodiments, the composition includes 95 wt-% or less, 80 wt-% or less, 65 wt-% or less, 55 wt-% or less, 45 wt-% or less, 25 wt-% or less, 15 wt-% or less, 5 wt-% or less, or 1 wt-% or less of short-strand PTFE fibrils based on the total weight of the composition and calculated according to the Composition Analysis Test Method. In some embodiments, the composition includes 0.01 wt-% or greater, 1 wt-% or greater, 5 wt-% or greater, 10 wt-% or greater, 15 wt-% or greater, 20 wt-% or greater, 30 wt-% or greater, or 40 wt-% or greater of long-strand PTFE fibrils based on the total weight of the composition and calculated according to the Composition Analysis Test Method. In some embodiments, the composition includes 50 wt-% or less, 40 wt-% or less, 30 wt-% or less, 20 wt-% or less, 15 wt-% or less, 10 wt-% or less, 5 wt-% or less, or 1 wt-% or less of the long-strand PTFE fibrils based on the total weight of the composition and calculated according to the Composition Analysis Test Method.

The plurality of PTFE fibrils, or the short-strand PTFE fibrils and the long-strand PTFE fibrils, may include various forms of PTFE such as C3-PTFE, C2-PTFE, C1-PTFE, or any combination thereof. C1-PTFE is a polytetrafluoroethylene polymer that includes the repeating group —(CF₂—C(F)(CF₃))—. C2-PTFE is a polytetrafluoroethylene polymer that includes the —(CF₂—C(F)(CF₂—CF₃))— repeating group. C3-PTFE is a polytetrafluoroethylene polymer that includes the —(CF₂—C(F)(CF₂—CF₂—CF₃))— repeating group. In some cases, it may be desirable to decrease the amount of fluorine in the final composition and/or decrease the amount of fluorine-carbon bonds used in the production of the PTFE. In some embodiments, the PTFE resin used to form the PTFE fibrils, and therefore the PTFE fibrils in the matrix, may include any combination of C1 short-strand PTFE, C2 short-strand PTFE, C3 short-strand PTFE, C1 long-strand PTFE, C2 long-strand PTFE, or C3-long-strand PTFE.

### Plurality of Active Particles

The matrices of the present disclosure include a plurality of active particles. The physical and/or chemical functionality of the particles making up the plurality of active particles may vary based on the intended use of a given matrix or composition comprising such matrix. The plurality of active particles may include a catalyst, a sorbent (e.g., an adsorbent, an absorbent, or both) a growth seed, an electroactive material, a metal-organic framework, a bioactive material, or any combination thereof.

In some embodiments, the plurality of active particles includes a catalyst. A catalyst is a chemical species that alters the rate of one or more reactions without being consumed. The matrix may include any suitable catalyst, or any combination of catalysts, for facilitating any desired reaction. In some embodiments, desirable reactions may include nitrobenzene reduction, nitrogen oxide (NOₓ) compound reduction, hydrogenation, or any combination thereof. Catalysts that are able to remove, prevent, and/or reduce the emission of harmful gasses into the atmosphere may be of particular interest. For example, the plurality of active particles may include a catalyst capable of reducing and/or converting one or more nitrogen oxide (NOₓ) compounds (e.g., nitric oxide, nitrogen dioxide, dinitrogen trioxide, and/or nitrate) into diatomic nitrogen. The catalysts may be grafted onto a support such as an adsorbent (described elsewhere herein).

In some embodiments, the catalyst is capable of destroying ozone (O₃); that is, the catalyst is able to convert ozone (O₃) to oxygen (O₂) by way of bond rearrangement. Examples of catalysts capable of ozone destruction include silicates such as iron silicates, iron manganese silicates, zinc iron silicates, or any combination thereof; transition metal oxides such as zinc oxide, manganese oxide, copper oxide, cerium dioxide, or any combination thereof; metals such as reduced metals (i.e., zero-valent metals) that include titanium, lead, iron, copper, zinc, chromium, cobalt, nickel, manganese, gold, silver, platinum, palladium, rhodium, tungsten, molybdenum, vanadium, zirconium, silicon, ruthenium, and combinations thereof; carbonates such as barium carbonate, magnesium carbonate, calcium carbonate, strontium carbonate, or any combination thereof; zeolites; and any combination thereof. A zeolite is an aluminosilicate compound made up of aluminum, oxygen, silicon, and one or more counterions.

In some embodiments, the catalyst is capable of performing hydrogenation and/or cross-coupling reactions. Such chemical transformations may be useful for small molecule synthesis. Examples of catalysts capable of initiating such reactions include platinum, palladium, rhodium, iridium, PdCl₂, iron, iron oxide, gold, silver, copper, copper oxide, compounds containing the same, and any combination thereof.

In some embodiments, the plurality of active particles include a catalyst capable of ozone destruction that includes manganese oxide (e.g., amorphous manganese oxide), copper oxide, or both. Amorphous materials have little to no crystallinity, which is in contrast to polymorphic materials. An example of an ozone destroying catalyst that includes amorphous manganese oxide is available from Carus LLC (La Salle, IL) under the tradename CARULITE 400. In some embodiments, the plurality of active particles include a catalyst capable of ozone destruction that includes cerium dioxide. In some embodiments, the plurality of active particles includes a catalyst capable of ozone destruction that includes manganese oxide, copper oxide, cerium dioxide, or any combination thereof.

In some embodiments, the active particles include a sorbent. In some embodiments, the sorbent is an adsorbent, an absorbent, or both. Examples of absorbents include cellulose, fumed silica, cotton, natural or synthetic sponge, clays, sodium polyacrylate, sodium alginate, gelatin, and wool.

In some embodiments, the plurality of active particles includes an adsorbent such as a physisorbent, a chemisorbent, a physisorbent-chemisorbent hybrid, or any combination thereof. In some embodiments, the adsorbent is a chemisorbent-physisorbent hybrid. Chemisorbent-physisorbent hybrids include grafted hybrids and impregnated hybrids. A grafted hybrid is a chemisorbent grafted onto a physisorbent or a physisorbent grafted onto a chemisorbent. An impregnated hybrid is a physisorbent impregnated with a chemisorbent or a chemisorbent impregnated with a physisorbent. Grafted hybrids are characterized as a chemisorbent being covalently linked to the physisorbent. Impregnated hybrids are characterized as the chemisorbent being located within the pores of a physisorbent. In impregnated hybrids the chemisorbent is held in the pore via non-covalent interactions (e.g., van der Waals forces). In some embodiments, a graft hybrid or an impregnated hybrid includes one or more of the following physisorbents, activated carbon, a zeolite, a silicate, a metal-organic framework (MOFs), or a mesoporous transition metal oxide.

An adsorbent is a material capable of adsorbing a chemical; that is, the material is capable of isolating a chemical on at least a portion of its surface area. A physisorbent is an adsorbent that isolates a chemical through the formation of weak interactions (e.g., van der Waals and/or electrostatic forces) between the physisorbent and the chemical being adsorbed. A chemisorbent is an adsorbent that isolates a chemical through the formation of an ionic or covalent bond between the chemisorbent and the chemical being adsorbed.

The identity of the adsorbent depends at least in part on the intended use of the composition. Adsorbents may be included that are capable of adsorbing basic compound, an acidic compound, an organic compound, an inorganic compound, or any combination thereof. Such adsorbents may be a physisorbent, a chemisorbent, or a physisorbent-chemisorbent hybrid. The acidic compound, basic compound, organic compound, inorganic compound, or any combination thereof may be in the liquid state, gaseous state and/or vapor state (preferably), or any combination thereof.

In some embodiments, the adsorbent is capable of adsorbing an organic compound in the liquid state, gaseous state and/or vapor state (preferably), or both. An organic compound is a compound that includes at least one carbon-hydrogen covalent bond. Examples of organic compounds that adsorbents can adsorb include aromatic hydrocarbons such as toluene, benzene, xylene, and ethylbenzene; siloxanes; polycyclic aromatic hydrocarbons such as the 16 polycyclic aromatic hydrocarbons classified as priority pollutants by the United States Environmental Protection Agency in 2005 (i.e., naphthalene, acenaphthylene, acenaphthene, fluorene, phenanthrene, anthracene, fluoranthene, pyrene, benz(a)anthracene, chrysene, benzo(b)fluoranthene, benzo(k)fluoranthene, benzo(a)fluoranthene, dibenz(a,h)anthracene, benzo(ghi)perylene, and indeno(1,2,3-cd)pyrene); n-alkanes such as methane, ethane, and n-propane, n-butane, n-pentane, and n-hexane; n-alkenes such as methylene, ethylene, propylene; various alcohols; aldehydes such as formaldehyde, siloxanes; and any combination thereof. Examples of adsorbents capable of adsorbing an organic compound include activated carbon, zeolites (e.g., zeolite X, zeolite A, zeolite Y, zeolite β, and zeolite ZSM-5), silicates, metal-organic frameworks (MOFs), mesoporous transition metal oxides, and any combination thereof.

In some embodiments, the adsorbent is capable of adsorbing an inorganic compound in the liquid state, gaseous state and/or vapor state (preferably), or both. An inorganic compound is a compound that does not have at least one carbon-hydrogen bond. Examples of inorganic compounds that adsorbents can adsorb include carbon dioxide; carbon monoxide; hydrogen sulfide; nitrogen oxides; sulfur oxides; water; perfluorocarbons such as tetrafluoromethane and hexafluoroethane; sulfur hexafluoride; ozone; and any combination thereof. Examples of adsorbents capable of adsorbing one or more inorganic compounds include activated carbon, zeolites (e.g., zeolite X, zeolite A, zeolite Y, zeolite β, and zeolite ZsM-5), silicates, metal-organic frameworks (MOFs), mesoporous transition metal oxides, and any combination thereof. Zeolite physisorbents are an example of an adsorbent capable of adsorbing ozone.

In some embodiments, the adsorbent is capable of adsorbing an acidic compound in liquid state, gaseous state and/or vapor state (preferably), or both. An acidic compound is a compound that when mixed with water at a pH of 7, acidifies the water such that the pH of the resultant solution is below 7. Acidic compounds may be inorganic compounds or organic compounds. Examples of acidic compounds that adsorbents can adsorb include sulfur dioxide, nitrogen dioxide, hydrogen sulfide, sulfur trioxide, nitric oxide, and any combination thereof. Examples of adsorbents capable of adsorbing an acidic compound and/or an acidic gas include chemisorbents that include a group I metal (Li, Na, K, Rb, Cs, Fr) carbonate; a metal oxide; a group I (Li, Na, K, Rb, Cs, Fr) metal hydroxide; a group II metal (Be, Mg, Ca, Sr, Ba, Ra) hydroxide; a group II metal (Be, Mg, Ca, Sr, Ba, Ra) oxide; an N-containing compound such as an amine (e.g., tetraethylenepentamine, ethylenediamine and 3-aminopropyltriethoxysilane), an imine (e.g., polyethyleneimine), and an ammonium salt (e.g., ammonium persulfate); or any combination thereof. In some embodiments, the selected chemisorbent may be grafted onto a physisorbent, or impregnated within a physisorbent such as activated carbon; a zeolite; a silicate; or any combination thereof.

In some embodiments, the adsorbent is capable of adsorbing a basic compound in liquid state, gaseous state and/or vapor state (preferably), or both. A basic compound is a compound that mixed with water at a pH of 7, basifies the water such that the pH of the resultant solution is above 7. Basic compounds may be inorganic compounds or organic compounds. Examples of basic compounds adsorbents can adsorb include ammonia and nitrogen trifluoride. Examples of adsorbents capable of adsorbing a basic compound include physisorbents such as activated carbon, zeolites, silicates, and combinations thereof. Additional examples of adsorbents capable of adsorbing a basic compound include chemisorbents that have a carboxylic acid (COOH) functional group. Examples of chemisorbent compounds that have a carboxylic acid functional group include citric acid, terephthalic acid, trimesic acid, tartaric acid, maleic acid, benzoic acid, oxalic acid, and combinations thereof. Chemisorbents capable of adsorbing a basic compound include inorganic acids such as boric acid, nitric acid, sulfuric acid, hydrochloric acid, hydrogen chloride, hydrogen fluoride, hydrogen bromide, phosphoric acid, perchloric acid, periodic acid, or any combination thereof. Such chemisorbents may be grafted onto or impregnated within a physisorbent such as activated carbon, a zeolite, a silicate, or any combination thereof.

In some embodiments, the plurality of active particles includes a metal-organic framework (MOF). As used herein, the term “metal-organic framework (MOF)” refers to a compound that includes clusters of metal ions coordinated to organic ligands which form two- or three-dimensional structures. MOFs may be an adsorbent (e.g., physisorbent, chemisorbent, or both), a catalyst, or both. Examples of MOF adsorbents include copper benzene-1,3,5-tricarboxylate (C₁₈H₆Cu₃O₁₂, also known as HKUST-1, Cu-BTC MOF, or MOF-199; available from NOVOMOF in Zofingen, Aargau, Switzerland); zirconium 1,4-dicarboxyenzene MOF (Zr₆O4(OH)₄(dicarboxylate)₆, also known as UiO-66; available from NOVOMOF, Switzerland); zirconium 4,4′-biphenyldicarboxylic acid MOF (Zr₆O₄(OH)₄(4,4′-biphenyldicarboxylic acid)₆, also known as UiO-67; available from NOVOMOF, Switzerland); and combinations thereof.

In some embodiments, the plurality of active particles includes a bioactive material. A bioactive material is a material derived from a biological system. The bioactive material may function as an adsorbent and/or a catalyst. Examples of bioactive materials include, proteins, nucleotides, nucleic acids, saccharides and polysaccharides, lipids, and any combination thereof. In some embodiments, the bioactive material is a protein such as an enzyme. Lactase is an example of an enzyme that may be used as a bioactive material.

In some embodiments, the plurality of active particles includes a growth seed. The growth seed may serve as the nucleation point for the synthesis of a metal-organic framework (MOF). In some such embodiments, the growth seed includes copper nitrate as a growth seed for a copper-based MOF such as copper benzene-1,3,5-tricarboxylate. In some embodiments, the growth seed includes trimesic acid as a growth seed for a copper-based MOF such as copper benzene-1,3,5-tricarboxylate. A growth seed may be reacted with one or more additional reagents prior to, during, or after matrix formation to from an MOF.

Each particle of the plurality of active particles has a particle size. The particle size is defined as the greatest distance across a particle. The average particle size of the plurality of active particles may vary based on the intended use of the composition and/or the chemical or physical properties of the active particles. The plurality of active particles may have an average particle size of 0.001 μm or greater, 0.01 μm or greater, 0.1 μm or greater, 1 μm or greater, 5 μm or greater, 10 μm or greater, or 100 μm or greater as measured according to the Dimensional Analysis Test Method. The plurality of active particles may have an average particle size of 500 μm or less, 100 μm or less, 10 μm or less, or 1 μm or less as measured according to the Dimensional Analysis Test Method.

Generally, smaller particle sizes may be preferred for particles that include catalysts due to their increased surface area and active site density available for catalyzing reactions. As such, in some embodiments where the plurality of active particles includes a catalyst, the average particle size of the plurality of active particles is 0.001 μm to 5 μm, 0.001 μm to 1 μm, or 0.001 μm to 0.1 μm as measured according to the Dimensional Analysis Test Method. Generally, active particles that include adsorbents with small particle sizes may be preferred as the smaller particle size may allow for larger surface area and greater diffusion. In some embodiments, where the plurality of active particles includes an adsorbent, the average particle size of the particles in the plurality of active particles is 0.001 μm to 100 μm, 1 μm to 100 μm, or 0.001 μm to 0.1 μm as measured according to the Dimensional Analysis Test Method.

The compositions and/or matrices of the present disclosure may have a variety of active particle amounts. The wt-% of active particles (or any individual component of the active particles) in a composition and/or matrix may be calculated according to the Composition Analysis Test Methods.

The sum of the wt-% for each component of active particles is considered the wt-% of the active particles that include the components of the active particles. For example, if an active particle includes activated carbon, the amount of the activated carbon is the wt-% of the active particles that include the activated carbon. If an active particle includes manganese oxide and copper oxide, the wt-% of active particles that include the manganese oxide and copper oxide is the sum of the wt-% of manganese oxide and the wt-% of the copper oxide.

The total active particle amount is the sum of the wt-% of the one or more components making up the plurality of active particles in a composition and/or matrix. For example, in embodiments where the active particles include manganese oxide and copper oxide, the total active particle wt-% in a matrix is the sum of the wt-% of the manganese oxide and the wt-% copper oxide.

In some embodiments, the total active particle wt-% in a composition and/or matrix is 50 wt-% or greater, 70 wt-% or greater, 80 wt-% or greater, or 90 wt-% or greater by weight of the composition and/or matrix, per the Composition Analysis Test Method. In some embodiments, the total active particle wt-% in the composition and/or matrix is 95 wt-% or less, 90 wt-% or less, 80 wt-% or less, or 70 wt-% or less by weight of the composition and/matrix, per the Composition Analysis Test Method. Stated differently, in some embodiments, the composition and/or matrix incudes 50 wt-% or greater, 70 wt-% or greater, 80 wt-% or greater, or 90 wt-% or greater active particles by weight of the composition and/or matrix, per the Composition Analysis Test Method. In some embodiments, the composition and/or matrix incudes 95 wt-% or less, 90 wt-% or less, 80 wt-% or less, or 70 wt-% or less active particles by the weight of the composition and/or matrix per the Composition Analysis Test Method.

For some uses or a composition and/matrix, it may be beneficial to have a low amount of active particles in the composition and/or matrix. In some embodiments, the total active particle wt-% in a composition and/or matrix is 0 wt-% or greater, 0.001 wt-% or greater, 0.01 wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater by weight of the composition and/or matrix, per the Composition Analysis Test Method. In some embodiments, the total active particle wt-% in a composition and/matrix is 20 wt-% or less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less, by weight of the composition and/or matrix, per the Composition Analysis Test Method. Stated differently, in some embodiments, the composition and/or matrix includes 0 wt-% or greater, 0.001 wt-% or greater, 0.01 wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater active particles by weight of the composition and/or matrix, per the Composition Analysis Test Method. In some embodiments, the composition and/or matrix incudes the matrix and/or composition includes 20 wt-% or less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less active particles, by weight of the composition and/or matrix, per the Composition Analysis Test Method.

### Matrices

Compositions of the present disclosure include a matrix. The matrix includes a plurality of PTFE fibrils and a plurality of active particles. In some embodiments, the plurality of PTFE fibrils includes short-strand PTFE fibrils and long-strand PTFE fibrils. The plurality of PTFE fibrils may have any of the chemical and/or physical properties described herein. The plurality of active particles may have any of the chemical and/or physical properties described herein.

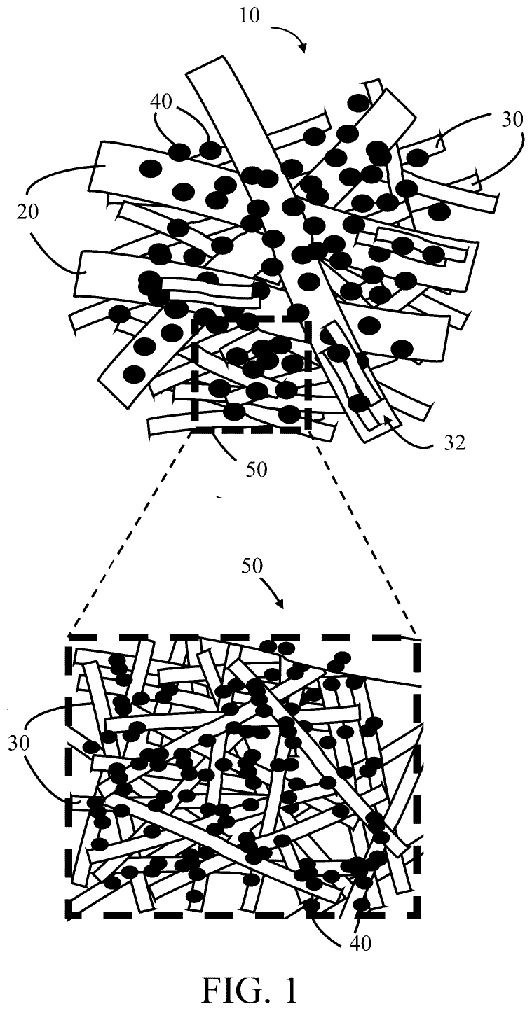

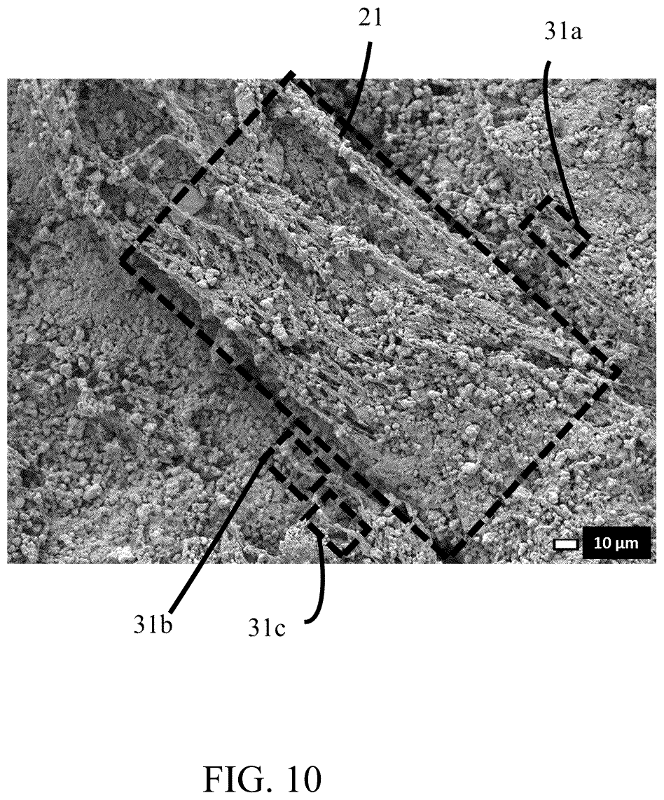

FIG. 1 shows a schematic illustration of a matrix consistent with embodiments of the present disclosure. The matrix 10, includes long-strand PTFE fibrils 20, short-strand PTFE fibrils 30, and a plurality of active particles 40. As described elsewhere herein, the fibrils of the long-strand PTFE fibrils 30 are longer and wider than the fibrils of the short-strand PTFE fibrils 30. The long-strand PTFE fibrils can be observed when the compositions of the present disclosure are imaged at a relatively low magnification (e.g., ×370; see FIG. 10). For example, a portion of a long-strand PTFE fibril can be seen in the SEM image of a matrix consistent with the present disclosure in FIG. 10 (box 21). The component fibrils making up the long-strand PTFE fibril are visible (box 21). In the same figure, unordered short-strand PTFE fibrils can be seen that are distinct from the long-strand PTFE fibril (box 31a, 31b, and 31c). As described elsewhere herein, one or more short-strand PTFE fibrils may be located within a long-strand PTFE fibril 32; however, the short-strand PTFE fibrils and the long-strand PTFE fibril are separate entities. As such, the short-strand PTFE fibrils located within long-strand PTFE fibrils are distinct from the plurality of component fibrils 22 (FIG. 2B) that make up the long-strand PTFE fibril. As discussed elsewhere herein, the component fibrils of the long-strand PTFE fibrils are longer than short-strand PTFE fibrils.

When imaged at a relatively high magnification (e.g., ×9,000; ×7,000; ×11,000; ×20,000), as illustrated in box 50 of FIG. 1, the plurality of small-strand PTFE fibrils have a largely unordered configuration; that is, the fibrils are extending in different directions (e.g., in the x, y, and z directions). This phenomenon can be clearly seen in the SEM image of a matrix consistent with the present disclosure in FIG. 9. Compositions that include only short-strand PTFE fibrils do not include two distinct populations of PTFE fibrils (i.e., short-strand PTFE fibrils and long-strand PTFE fibrils). As discussed, a composition having a single population of PTFE fibrils (e.g., short-strand PTFE fibrils) and a composition having two populations of PTFE fibrils (e.g., short-strand PTFE fibrils and long-strand PTFE fibrils), can be distinguished using microscopy (e.g., scanning electron microscopy).

The plurality of active particles are distributed across the matrix and contact and/or interact with the long-strand PTFE fibrils 20 (if present), the short-strand PTFE fibrils 30, or both (FIG. 1). Active particles that are interacting with other active particles, the long-strand PTFE fibrils 20 (if present), the short-strand PTFE fibrils 30, or combinations thereof are physically and/or chemically immobilized in the matrix. That is, the term “interaction” refers to a physical force (e.g., frictional force, gravitational force, compression force, tensile force, electrical force, magnetic force, spring force, applied force, and normal force) or a chemical force (e.g., van der Waals force, Debey force, Keesom force, London dispersion force, dipole-dipole force, and hydrogen bonding) between two or more active particles, an active particle and a short-strand PTFE fibril (or multiple short-strand PTFE fibrils), an active particle and a long-strand PTFE fibril (if present; or multiple long-strand PTFE fibrils), or combinations thereof.

The plurality of active particles may have one or more configurations in which they interact with the short-strand PTFE fibrils, the long-strand PTFE fibrils (if present), or both. In some embodiments, at least a portion of the plurality of active particles and at least a portion of the plurality of the PTFE fibrils adopt a catenated structure, a conglomerated structure, or both. In some embodiments, at least a portion of the plurality of active particles form a catenated structure around one or more short-strand PTFE fibrils, one or more long-strand PTFE fibrils (if present), or both; at least a portion of the plurality of active particles form a conglomerated structure with the one or more short-strand PTFE fibrils, one or more long-strand-PTFE fibrils (if present), or any combination thereof.

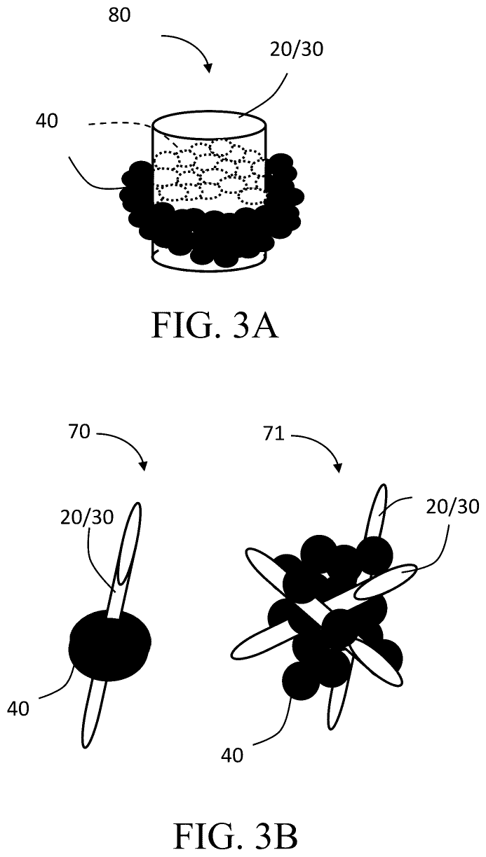

The terms “catenated structure” and “catenation structure” are used interchangeably to refer to a self-supporting network of active particles that encapsulate at least a portion of one or more PTFE fibrils. FIG. 3A is a schematic representation of a catenated structure 80. In a catenated structure, a plurality of active particles 40 form a self-supporting network that encapsulates at least a portion of one or more PTFE fibrils 20/30 (e.g., one or more long-strand PTFE fibrils, one or more short-strand PTFE fibrils, or both). While the self-supporting network may be contacting and/or interacting with the one or more PTFE fibrils that it at least partially encapsulates, the primary interaction holding the catenated structure together is the physical interaction between adjacent particles. Without wishing to be bound by theory, it is thought that if the at least partially encapsulated (or entirely encapsulated) PTFE fibril could be removed, the self-supporting network of particles would remain undisturbed. Individual active particles that are involved in a catenated structure may not be well defined because the active particles may merge into one another to create the self-supporting network.

The self-supporting network of active particles can encapsulate a portion of a single PTFE fibril, a portion of multiple PTFE fibrils, an entire PTFE fibril, or the entirety of multiple PTFE fibrils in a catenated structure. The self-supporting network of active particles may encapsulate at least a portion of one or more short-strand PTFE fibrils, at least a portion of one or more long-strand PTFE fibrils, or both in a catenated structure. It is generally thought that catenated structures primarily include the encapsulation of at least a portion of one or more short-strand PTFE fibrils.

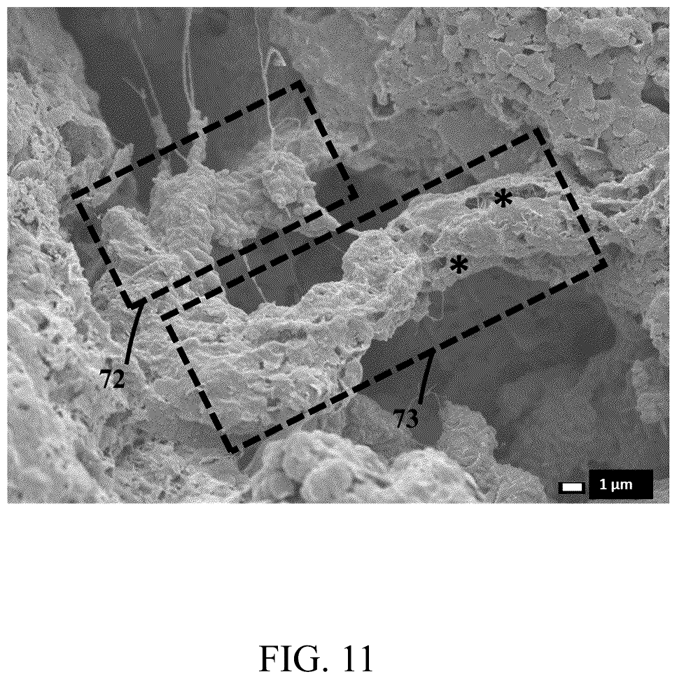

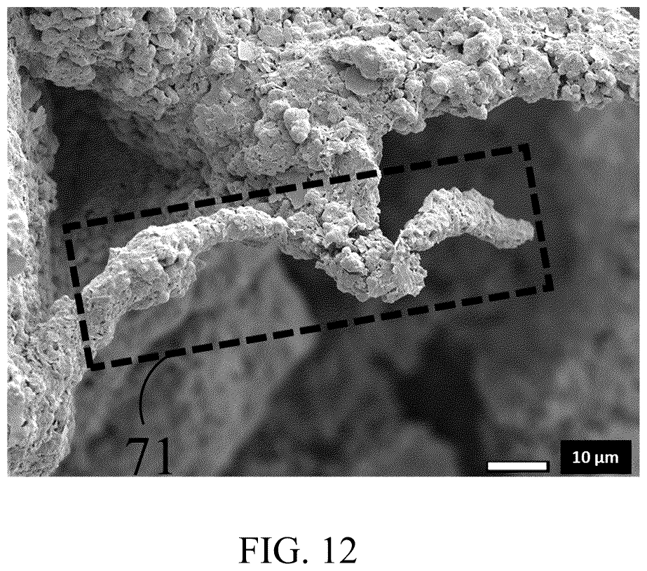

FIG. 11 and FIG. 12 are SEM images of compositions consistent with embodiments of the present disclosure that clearly demonstrate catenated structures as highlighted in boxes 71, 72, and 73. In these images, particles form a self-supporting network, or “bead-like” structure, surrounding one or more PTFE fibrils (e.g., the one or more PTFE fibrils is the string, and the self-supporting network of particles is the bead). The extent of the catenated structure in box 71 is such that the one or more of PTFE fibrils cannot be seen (e.g., the PTFE fibril or fibrils are fully encapsulated by the catenated structure). In contrast, in the catenated structures shown in boxes 72 and 73, a portion of the PTFE fibril, or fibrils, involved in the catenated structures are encapsulated within the self-supporting network of active particles. For example, the catenated structures may have gaps in which individual PTFE fibrils can be observed (denoted in FIG. 12 by an *).

Without wishing to be bound by theory, it is thought catenated structures may reduce the likelihood of particle shedding from the composition (e.g., before, during, and/or after disposing on a porous substrate). Additionally, it is thought that particles adopting a catenated structure may have a large, exposed surface area due to their spacing and number of exposed faces. This property may increase their activity as catalysts, adsorbents, growth seeds, MOFs, or any combination thereof.

As used herein, the terms “conglomerated structure” and “conglomeration structure” are used interchangeably and refer to an active particle or an aggregate of active particles that is at least partially held together by one or more PTFE fibrils (e.g., short-strand PTFE fibrils or long-strand PTFE fibrils). In contrast to a catenated structure, the particles of a conglomerated structure do not form a self-supporting network that is generally independent of the PTFE fibrils. In a conglomerated structure, an active particle or aggregate of active particles are held in place through an interaction with one or more PTFE fibrils (e.g., short-strand PTFE fibrils) that extend through (e.g., run through) the particle or aggregate. An aggregate of active particles is a cluster of two or more active particles, each active particle interacting with at least one other active particle of the cluster. In a conglomerated structure that includes an aggregate, the aggregate is held together both through interactions between active particles and interactions between active particles and PTFE fibrils. In contrast to a catenated structure, the active particles of conglomerated structures are generally well defined.

FIG. 3B is a schematic representation of two conglomerated structures 70 and 71 that are consistent with embodiments of the present disclosure. Conglomerated structure 70 is a PTFE fibril from a plurality of PTFE fibrils 20/30 (short-strand PTFE fibril or long-strand PTFE fibril) running through (i.e., interacting with) a single active particle from a plurality of active particles 40. Conglomerated structure 71 is several PTFE fibrils from a plurality of PTFE fibrils 20/30 running through (i.e., interacting with) an aggregate that includes a plurality of active particles 40.

FIG. 9 is an SEM image of a composition consistent with embodiments of the present disclosure that demonstrates various conglomerated structures as highlighted in boxes 81, 82, 83, and 84. Box 81, box 82, and box 83 show a conglomerated structure that has multiple short-strand PTFE fibrils running through an aggregate of active particles. Box 84 shows a conglomerated structure where multiple short-strand PTFE fibrils are running through a single active particle.

Without wishing to be bound by theory, it is thought that conglomerated structures may impart some degree of mechanical stability to at least a portion of the plurality of active particles, at least a portion of the plurality of PTFE fibrils (e.g., long-strand PTFE fibrils, short-strand PTFE fibrils, or both), or both. For example, it is thought that a conglomerated structure may at least partially inhibit one or more of the PTFE fibrils participating in the conglomerated structure from contracting (i.e., decreasing in length). Additionally, conglomerated structures are thought to reduce the likelihood of particle shedding due to the strength imparted by the PTFE fibrils with which the particles of a conglomerated structure are interacting.

### Free Active Particles and Free PFTE Fibrils

The compositions of the present disclosure include a matrix such as those described herein. In some embodiments, the composition may include one or more additional components. Example additional components include free active particles and free PTFE fibrils. In a porous substrate that has a composition disposed thereon, individual components of a composition may or may not be located at different locations of the porous substrate (e.g., on the major surface, impregnated within the substrate, or embedded within the substrate) such as described elsewhere herein.

In some embodiments, the composition includes free active particles. The free active particles are distinct from the plurality of active particles in the matrix in that the free active particles do not interact with the plurality of PTFE fibrils (or free PTFE fibrils as discussed elsewhere herein). Free active particles are embedded or impregnated within the porous substrate. As such, the term “free active particles” refers to active particles that are embedded or impregnated within the porous substrate and are not interacting with one or more PTFE fibrils. The free active particles may have any chemical and/or physical identity as disclosed herein. In some embodiments, the plurality of active particles and the free active particles are made from the same material (e.g., have the same chemical and/or physical identity). For example, in some embodiments the plurality of active particles includes a catalyst, and the free active particles includes the same catalyst. In some embodiments, the plurality of active particles and the free active particles are made from different materials (e.g., have different chemical and/or physical identities). For example, in some embodiments, the plurality of active particles may include a catalyst and the free active particles may include an adsorbent. In some embodiments, the plurality of active particles may include a first adsorbent and the free active particles may include a second adsorbent that is different from the first adsorbent.

In some embodiments, the composition includes free PTFE fibrils. The free PTFE fibrils are distinct from the plurality of PTFE fibrils in the matrix in that the free PTFE fibrils are not a part of a fibril-active particle matrix structure. Free PTFE fibrils do not interact with the matrix or free active particles; however, two or more free PTFE fibrils may interact. Free PTFE fibrils are embedded or impregnated within the porous substrate. As such, the term “free PTFE fibrils” refers to PTFE fibrils that are embedded or impregnated within the porous substrate and are not interacting with the matrix or free active particles. Free PTFE fibrils may interact with each other. The free PTFE fibrils may be short-strand PTFE fibrils, long-strand PTFE fibrils, or both.

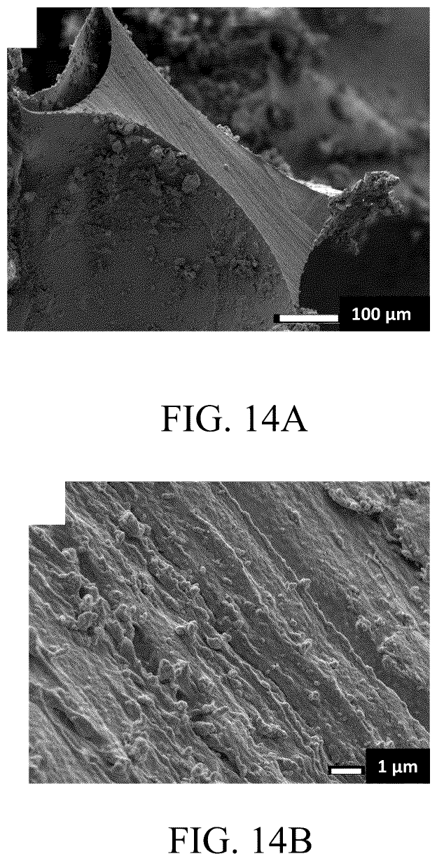

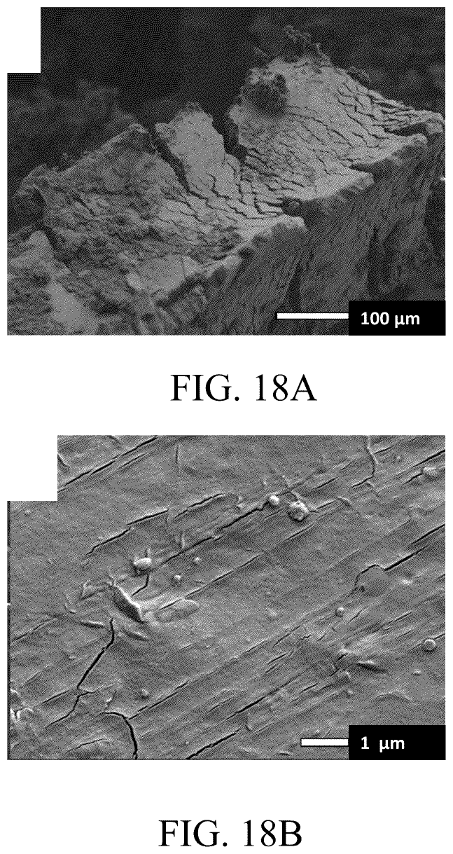

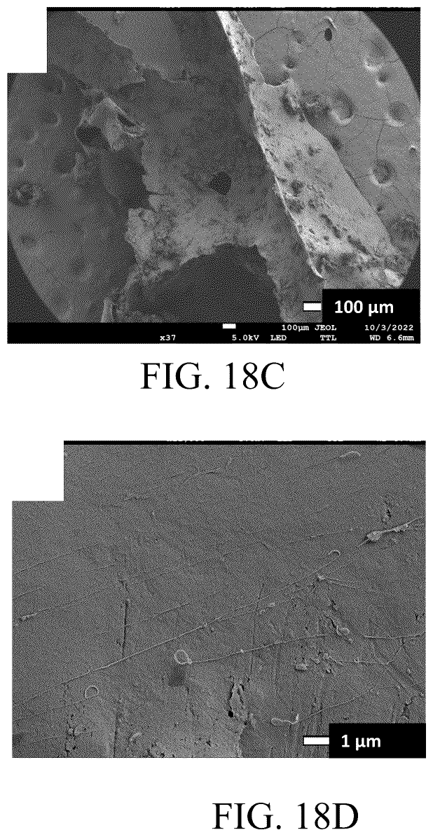

Free active particles and free PTFE fibrils may be visualized using microscopy, such as scanning electron microscopy. FIG. 18D shows an example image of free PTFE fibrils. FIG. 18D is image of a porous substrate that has the has a composition consistent with embodiments of the present disclosure disposed thereon. Free PTFE fibrils can be seen running across the surface. These fibrils are not interacting with the matrix or free active particles. FIG. 14B shows an example of free active particles embedded and/or impregnated within a porous substrate. FIG. 14B is a cross section of a porous substrate to which a composition consistent with embodiments of the present disclosure has been disposed on. Small particles (active particles) can be seen in-parallel with the substrate polymer grains. The particles are not interacting with a matrix or free PTFE fibrils.

### Porous Substrates Having a Composition Disposed Thereon

The present disclosure provides porous substrates with compositions and/or components of the present disclosure disposed thereon. Such substrates may be further processed into various materials, such as filter media, membranes, reticulated foams, or reactionary surfaces for secondary material coordination. The materials may further be included in filters; may be used as catalytic media for various chemical syntheses in petrochemical or pharmaceutical applications; may be used as air intake filters for engine air systems; or may act as destructive catalysts for chemical protection of membrane materials.

Porous substrates with compositions disposed thereon may have the composition disposed on at least a portion of a major surface; the composition impregnated within the substrate, the composition embedded within the substrate; or any combination thereof.

### Porous Substrates

The substrates or the present disclosure are porous substrates. Porous substrates are defined by one or more major surfaces. A major surface is a surface of the substrate that forms an interface with the surrounding environment. Pores may be coupled to the major surface of a substrate. Pores coupled to a major surface are pores that are accessible to fluid (i.e., liquid or gas) or solids through the external surface. Pores coupled to the major surface are not considered a part of the major surface because the volume of the pore extends into the interior of the substrate. For example, the major surfaces of a porous substrate that is a cube are the facets of the cube. The major surface can have topography that is constant or that varies in the x, y, and/or z directions. For example, each one of the major surfaces of a porous substrate can be smooth or rough. The porous substrate may have a single continuous major surface, such as, for example, a spherical or ovoid substrate. The porous substrate may have multiple major surfaces such as, for example, a polyhedron.

Porous substrates have a plurality of pores. A pore is defined is a void space within the interior of a substrate. The void space of the pore is defined by a pore surface. The total amount of void space is the pore volume. Pores may be a through pore, an open pore, or a blind pore. A through pore is a pore that is connected to (e.g., accessible from) a major surface by two or more pore openings. An open pore is a pore that is connected to (e.g., is accessible from) a single pore opening on one major surface. A blind pore is a pore that is no connected to a pore opening on a major surface. Pores may have a variety of morphologies.

Porous substrates include a plurality of macro pores. Macro pores are pores that exist between portions of the material that make up the porous substrate (e.g., between polymer networks). Generally, macro pores have a pore opening size of 1 mm or greater, some of which can be seen with the naked eye. The composition may impregnant a portion of the macro pores of the porous substrate (as discussed elsewhere herein). Macro pores may be through pores, blind pores, or open pores.

A porous substrate may include a plurality of micro pores. Micro pores are pores that exist between solid portions of the material that make up the porous substrate. Micro pores have a pore opening size of less than 1 mm. In some cases, a micro pore may exist within the pore wall of a macro pore. The composition may impregnant a portion of the micro pores of the porous substrate (as discussed elsewhere herein). Micro pores may be through pores, blind pores, or open pores. Micro pores may be collapsible pores as defined herein or may not be collapsible pores.

The term macro/micro is understood as meaning macro pores and/or micro pores if micro pores are present. It is understood that the micro pores associated with the macro/micro term are not collapsible pores.

In some embodiments, porous substrates made of a wettable polymeric material may include a plurality of collapsible pores. Collapsible pores are the interstitial space between polymer chains within the solid portion of the substrate in which the composition may become embedded (as discussed elsewhere herein). Collapsible pores are in a collapsed state within the substrate backbone and are not accessible to a fluid or a solid prior to wetting the wettable material. Wetting the wettable material may expand the collapsible pore allowing such pore to be accessible to a fluid or solid. Drying of the wettable material may cause a collapsible pore to collapse thereby trapping some or none or the material within the pore at the time of collapse in the interstitial space between polymer chains.

The porous substrate may be made of any suitable material. Some porous substrates are made of a wettable material. A wettable substrate is a substrate made of a material that is capable of absorbing some quantity of liquid to expose collapsible pores. A wettable porous substrate may be a foam. A wettable porous substrate may be a reticulated foam. The term reticulated foam is typically used to refer to open-cell foams that form a net or a mesh shape (as opposed to closed-cell foams that form bubble or cell shapes). The majority of pores in a reticulated foam may be open pores and/or through pores. Reticulated foams typically are very porous and have a low density. For example, reticulated foams may have a porosity of 60% or greater, 90% or greater or 95% or greater. Reticulated foams may be polymer-based; metal-, metal oxide-, or metal carbide-based; carbon-based; ceramic based; or any combination thereof. Reticulated foams may be made of more than one material even though only one material is stated. Examples of polymer-based reticulated foams include reticulated polyester, reticulated polyether, reticulated polyurethane, reticulated polyurethane without heat treatment, reticulated cellulose, and reticulated melamine. Examples of carbon-based reticulated foams include reticulated activated carbon, reticulated vitreous carbon, and reticulated graphene. Examples of metal-based reticulated foams include reticulated foams made from reduced metals (i.e., zero-valent metals) such as titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof; reticulated alloys such as reticulated steal; or any combination thereof. Examples of metal oxide-based reticulated foams include reticulated silicon oxide. Examples of metal carbide-based reticulated foams include reticulated silicon carbide.

The reticulated foam may have any suitable number of pores per inch (PPI). For example, the reticulated foam may 3 PPI or greater, 10 PPI or greater, 20 PPI or greater, 30 PPI or greater, 40 PPI or greater, 50 PPI or greater, 60 PPI or greater, 70 PPI or greater, 80 PPI or greater, 90 PPI or greater or 100 PPI or less, 90 PPI or less, 80 PPI or less, 70 PPI or less, 60 PPI or less, 50 PPI or less, 40 PPI or less, 30 PPI or less, 20 PPI or less, or 10 PPI or less.

### Impregnated Porous Substrate

In some embodiments, a porous substrate having a composition disposed thereon is impregnated with the composition. In some such embodiments, at least a portion of the macro/micro pores of the porous substrate are impregnated with a composition of the present disclosure. The macro/micro pores may be impregnated with the composition or one or more components of the composition (e.g., matrix, free active particles if present, free PTFE particles if present, or any combination thereof).

The term “impregnated” used in the context of a porous substrate, refers to a porous substrate that includes a macro/micro pore having a macro/micro pore surface that is at least partially coated with the composition; a macro/micro pore having a macro/micro pore area that is partially or completely filled with the composition; or both. For example, in some embodiments, the substrate may include a portion of macro/micro pores having a macro/micro pore surface that is partially or fully coated with the composition. In some embodiments, the substrate may include a portion of macro/micro pores that have a macro/micro pore volume that is partially or completely filled with the composition. In some embodiments, the substrate may include a portion of macro/micro pores that have a macro pore volume that is partially or completely filled with the at least one particle of the free active particles.

In some embodiments where the composition includes free active particles, the substrate may include a first portion of macro/micro pores impregnated with the composition and a second portion of macro/micro pores impregnated with at least one particle of the free active particles. In some embodiments where the composition includes free active particles, the substrate may include a first portion of macro/micro pores impregnated with the composition; a second portion of macro/micro pores impregnated with at least one particle of a free active particles; and a third portion of macro/micro pores impregnated with the composition and at least one particle of the free active particles.

### Embedded Porous Substrate

In some embodiments, a composition is embedded with the solid portion of the porous substrate. A composition and/or one or more components of the composition (e.g., matrix, free active particles if present, free PTFE particles if present, or any combination thereof) may be embedded within a porous substrate.

The terms “embedded” and “embedment” in reference to a porous substrate refer to a composition that intercalated (e.g., inserted into) a collapsible pore of the substrate and remain in the solid portion of the substrate at or proximate to the location of the collapsible pore after the collapsible pore has at least partially collapsed. Collapsible pores are formed when a wettable substrate absorbs a wetting liquid and expands to expose interstitial spaces in which the composition may intercalate. Upon removal of a sufficient amount of the wetting liquid, the substrate contracts and any components of the compositions that were intercalated in the collapsible pores at the time of contraction become embedded within the solid portion of the substrate.

Without wishing to be bound by theory, it is thought that the embedment of the composition or components of the composition within the substrate may impart a degree of mechanical strength to the substrate. For example, it is thought that embedded free PTFE fibrils (long-strand and/or short-strand) increase the mechanical strength of the substrate thereby increasing its stability to microcracking.

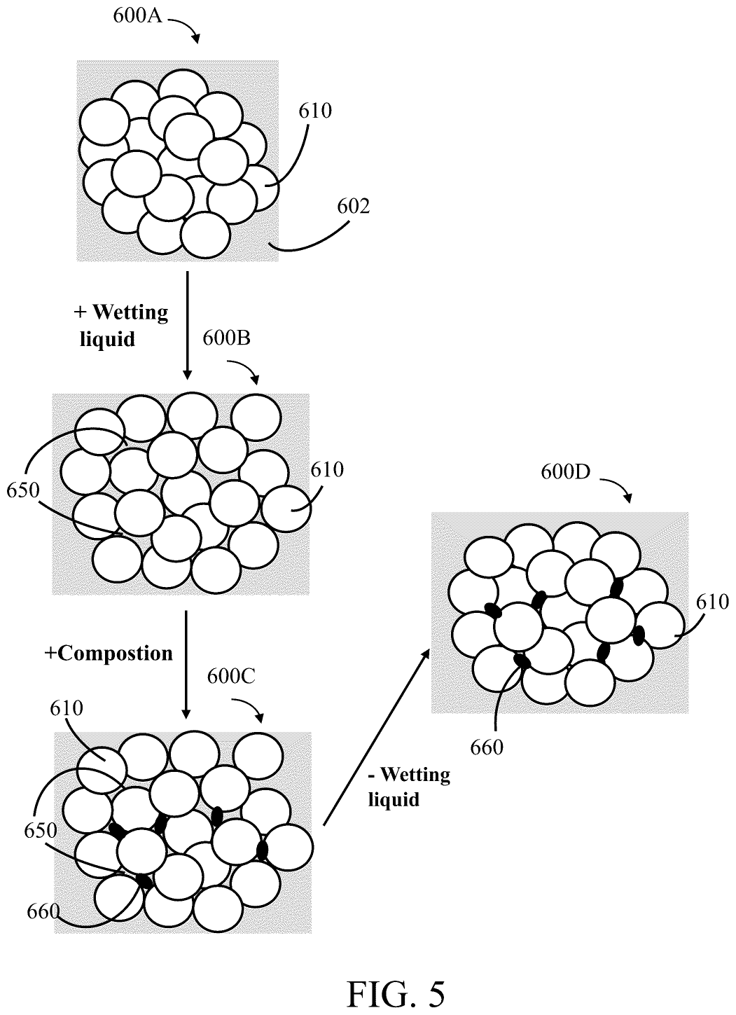

FIG. 5 shows a schematic representation of the formation of collapsible pores and the embedment of a composition within a porous substrate through intercalation of such pores. FIG. 5 is a cross sectional view of the solid portion of a wettable porous substrate 600A made up of a plurality of polymer chains 610. Background 602 is included for clarity. Before wetting liquid is added, the collapsible pores are in a collapsed state. Upon the addition of a wetting liquid, the substrate absorbs a portion of the wetting liquid and expands to form an expanded substrate 600B that includes newly exposed collapsible pores 650. If a composition is present, the composition and/or individual components of the composition 660 (e.g., the matrix, free active particles, dissolved components of free active particles that can precipitate to form free active particles, free PTFE fibrils, or any combination thereof) of the composition can migrate into the newly exposed collapsible pores 650 to form an intercalated substrate 600C. Removal of at least a portion of the wetting liquid results in the collapse of the collapsible pores as the polymer chains come back together thereby embedding the intercalated components within the solid portion of the substrate to form and embedded substrate 600D. In embodiments where the dissolved components that make up at least a portion of the free active particles, removal of the at least a portion of the wetting liquid may result in the supersaturation and precipitation of the dissolved components to create free active particles that are embedded within the substrate. Without wishing to be bound by theory, it is thought that embedded free active particles may be less sterically blocked than the plurality of active particles that are a part of the matrix. As such, the embedded free active particles may be more available to function as catalysts and/or adsorbents.

FIG. 18D shows a scanning electron micrograph of a cross section of an embedded substrate. Embedded PTFE fibrils can be seen running along the surface of the cross section.

### Porous Substrates Having a Composition Disposed on at Least a Portion of a Major Surface, the Composition Embedded Within the Substrate, the Composition Impregnated Within at Least a Portion of Macro Micro Pores, or any Combination Thereof.

Porous substrates having a first portion of composition disposed on at least a portion of a major surface and impregnated with a second portion of the composition are disclosed. In some such embodiments, at least a portion of a plurality of macro/micro pores of the substrate impregnated with the composition are disclosed. In some embodiments, the porous substrate has a first portion of the plurality of macro/micro pores impregnated with the composition and a second portion of the plurality of macro/micro pores impregnated with a component of the composition. In some such embodiments where the composition includes free active particles, the porous substrate has a first portion of macro/micro pores impregnated with the matrix or the composition as a whole and a second portion of macro/micro pores impregnated with at least one particle of the free active particles.

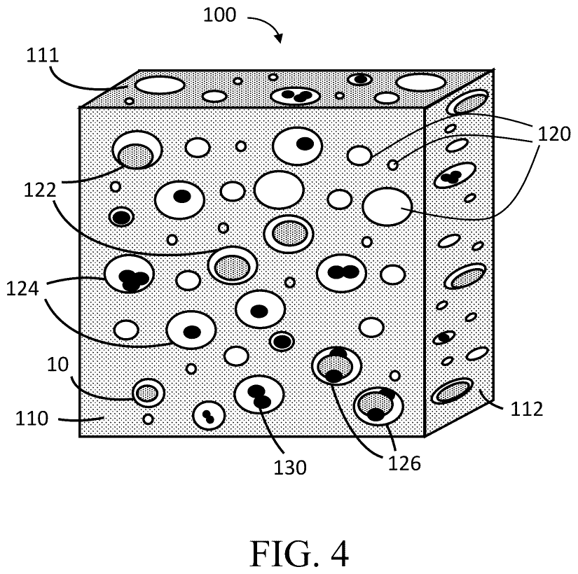

FIG. 4 is a schematic illustrating a porous substrate having at least a portion of a major surface coated with a first portion of the composition of the present disclosure; a first portion of macro/micro pores impregnated with a second portion of the composition; and a second portion of macro/micro pores impregnated with at least a one free active particle. The porous substrate 100 includes six major surfaces although only 3 major surfaces are depicted (110, 111, 112). At least a portion of each of the major surfaces are coated with a first portion of the composition 10. The porous substrate includes a plurality of macro/micro pores 120 having at least one macro/micro pore opening coupled to a major surface, the macro/micro pores having different pore opening diameters and morphologies. At least a portion of the plurality of macro/micro pores 120 are impregnated with a second portion of the composition 10, at least one particle of the free active particles 130, or both. For example, a first portion 122 of the plurality of macro/micro pores 120 is impregnated with the second portion of the composition 10. In some embodiments, at least a portion of the interior surface of one or more macro/micro pores of the first portion 122 of the plurality of macro/micro pores 120 may be coated with the second portion of the composition 10. In some embodiments, at least a portion of the macro/micro pore volume of one or more pores of the pores of the first portion 122 of the plurality of pores 120 may be filled with the second portion of the composition 10. In some embodiments, the entirety of the macro pore volume of one or more of the pores of the first portion 122 of the plurality of macro/micro pores may be filled with the second portion of the composition 10. A second portion 124 of the plurality of macro/micro pores 120 may be impregnated with one or more particles of the free active particles 130. A third portion 126 of the plurality of macro/micro pores 120 may be impregnated with both the composition (a third portion) 10 and at least one particle of the free active particles 130.

Porous substrates having a first portion of the composition of the present disclosure disposed on at least a portion of one or more major surfaces and having a second portion of the composition embedded within the substrate are disclosed. In some such embodiments, multiple components of a composition may be embedded within the substrate. For example, in some embodiments, one or more free PTFE fibrils, one or more free active particles, the matrix, or any combination thereof may be embedded within the substrate. In some embodiments, the porous substrates of the present disclosure have the composition disposed on at least a portion of one or more major surfaces and at least one free PTFE fibril (e.g., a short-strand PTFE fibril) embedded within the substrate.

Porous substrates having a first portion of the composition of the present disclosure disposed on at least a portion of one or more major surfaces; impregnated with a second portion of the composition; and having a third portion of the composition embedded within are disclosed. In some such embodiments, at least a portion of the macro/micro pores of the substrate are impregnated with the second portion of the composition. In some embodiments, the porous substrate has a first portion of macro/micro pores impregnated with a first component of the composition (e.g., the matrix) and a second portion of macro/micro pores impregnated with a second component of the composition (e.g., free active particles). In some such embodiments, multiple components of the third portion of the composition may be embedded within the substrate. In some embodiments, at least one free PTFE fibril (e.g., a small-strand PTFE fibril) is embedded within the substrate. In some embodiments, at least one free active particle is embedded within the substrate.

In some embodiments, a larger amount of the composition is impregnated or embedded within the porous substrate than is disposed on at least a portion of the major surface of the substrate. In some such embodiments, the amount of the composition disposed on at least a portion of the major surface results in a thin layer of the composition on the major surface. Without wishing to be bound by theory, it is thought that embedment of the matrix and/or free active particles within the solid portion of the substrate backbone may be advantageous from an adsorption perspective. For example, in embodiments where a thin film of the composition is disposed on at least a portion of the major surface, the pressure drop across the porous substrate may be smaller than the pressure drop across a porous substrate that has a thicker film of the composition disposed on the major surface. Additionally, substrates having a thin film of the composition disposed on a major surface may allow for the molecular diffusion rate to not be as greatly influenced by the thickness and porosity of the film as compared to a porous substrate that includes a thick film of the composition disposed on the major surface.

The wt-% of each component of a porous substrate having a composition disposed thereon may be determined according to the Composition Analysis Test Method.

In some embodiments, the porous substrate having a composition disposed thereon includes 0.001 wt-% or greater, 0.01 wt-% or greater, 0.1 wt-% or greater, 5 wt-% or greater, 10 wt-% or greater, 20 wt-% or greater, 30 wt-% or greater, 40 wt-% or greater, 50 wt-% or greater, 60 wt-% or greater, 70 wt-% or greater, 80 wt-% or greater, 90 wt-% or greater, or 95 wt-% or greater of the porous substrate based on the total weight of the substrate-composition (the total weight of the substrate and the composition disposed thereon) and calculated according to the Composition Analysis Test Method. In some embodiments, the porous substrate having a composition disposed thereon includes 99 wt-% or less, 95 wt-% or less, 90 wt-% or less, 80 wt-% or less, 70 wt-% or less, 60 wt-% or less, 50 wt-% or less, 40 wt-% or less, 30 wt-% or less, 20 wt-% or less, 10 wt-% or less, 5 wt-% or less, 1 wt-% or less, or 0.01 wt-% or less of the porous substrate based on the total weight of the substrate-composition and calculated according to the Composition Analysis Test Method.

In some embodiments, the porous substrate having a composition disposed thereon includes 0.001 wt-% or greater, 0.01 wt-% or greater, 0.1 wt-% or greater, 5 wt-% or greater, 10 wt-% or greater, 20 wt-% or greater, 30 wt-% or greater, 40 wt-% or greater, 50 wt-% or greater, 60 wt-% or greater, 70 wt-% or greater, 80 wt-% or greater, 90 wt-% or greater, or 95 wt-% or greater of the composition based on the total weight of the substrate-composition and calculated according to the Composition Analysis Test Method. In some embodiments, the composition having a composition disposed thereon includes 99 wt-% or less, 95 wt-% or less, 90 wt-% or less, 80 wt-% or less, 70 wt-% or less, 60 wt-% or less, 50 wt-% or less, 40 wt-% or less, 30 wt-% or less, 20 wt-% or less, 10 wt-% or less, 5 wt-% or less, 1 wt-% or less, or 0.01 wt-% or less of the composition based on the total weight of the substrate-composition and calculated according to the Composition Analysis Test Method.

In some embodiments, the porous substrate having a composition disposed thereon includes 0 wt-% or greater, 1 wt-% or greater, 2 wt-% or greater, 3 wt-% or greater, 4 wt-% or greater, 5 wt-% or greater, 10 wt-% or greater, or 15 wt-% or greater, 20 wt-% or greater, 30 wt-% or greater, 40 wt-% or greater, 50 wt-% or greater, 70 wt-% or greater, 80 wt-% or greater, or 90 wt-% or greater active particles based on the total weight of the substrate-composition and calculated according to the Composition Analysis Test Method. In some embodiments, the porous substrate having a composition disposed thereon includes 95 wt-% or less, 90 wt-% or less, 80 wt-% or less, 70 wt-% or less, 50 wt-% or less, 40 wt-% or less, 30 wt-% or less, 20 wt-% or less, 15 wt-% or less, 10 wt-% or less, 5 wt-% or less, 4 wt-% or less, 3 wt-% or less, 2 wt-% or less, or 1 wt-% or less active particles based on the total weight of the substrate-composition and calculated according to the Composition Analysis Test Method.

In some embodiments, the porous substrate having a composition disposed thereon composition includes 1 wt-% or greater, 5 wt-% or greater, 15 wt-% or greater, 25 wt-% or greater, 45 wt-% or greater, 55 wt-% or greater, 65 wt-% or greater, or 80 wt-% or greater of PTFE fibrils (total of short-strand PTFE fibrils and long-strand PTFE fibrils) based on the total weight of the substrate-composition and calculated according to the Composition Analysis Test Method. In some embodiments, the composition comprises 95 wt-% or less, 80 wt-% or less, 65 wt-% or less, 55 wt-% or less, 45 wt-% or less, 25 wt-% or less, 15 wt-% or less, or 5 wt-% or less PTFE fibrils based on the total weight of the substrate-composition and calculated according to the Composition Analysis Test Method.

### Methods

Methods of disposing the compositions of the present disclosure on porous substrates to make the porous substrates of the present disclosure are disclosed.

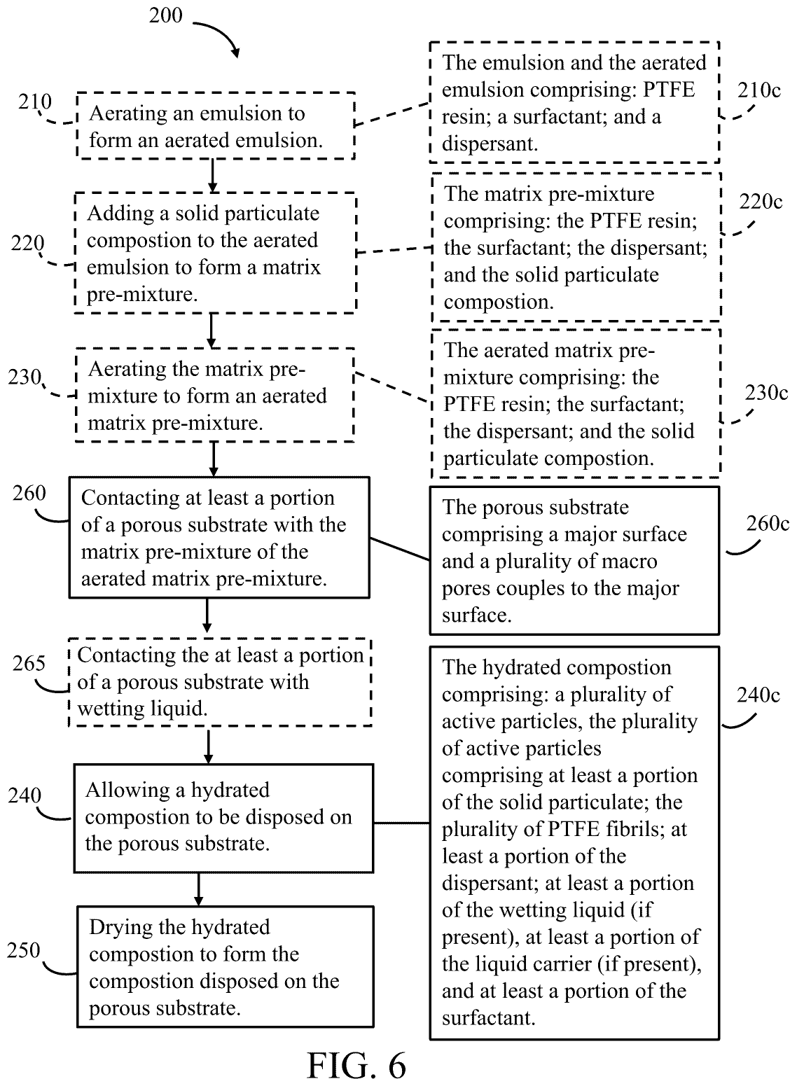

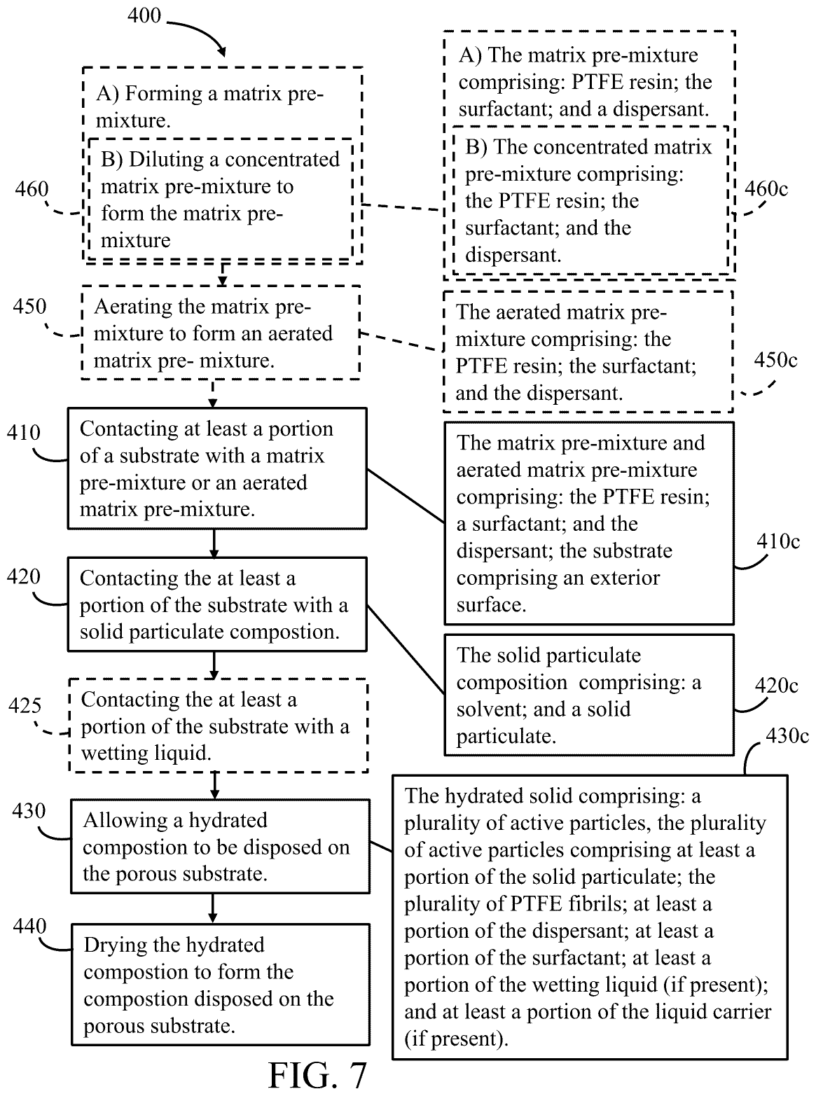

FIG. 6, FIG. 7, and FIG. 8 are flow diagrams showing aspects of illustrative methods disclosed herein. The steps may be conducted in any order. In some embodiments, multiple steps may be conducted at the same time. Steps shown in dashed boxes are optional steps. Each optional step may be performed in a method that includes none or one or more of any additional optional steps (if multiple optional steps are included). For example, a first optional step may be performed in conjunction with one or more additional optional steps; or performed not in conjunction with an additional optional step. Also included in the flow diagrams are boxes directed to the components making up the various compositions (e.g., concentrated matrix pre-mixture, matrix pre-mixture, emulsion, aerated emulsion, aerated matrix pre-mixture, hydrated composition, etc.) in the methods. Such boxes have an element number designated with a “c.” It is understood that a component included in a step is also included in any downstream step, with the exception of the drying steps. For example, a dispersant included in a first step is subsequently include in a second step, third step, and so on until a drying step is completed, in which case the dispersant may be at least partially eliminated during the drying step.

FIG. 6 is a flow diagram outlining a first illustrative method for disposing the compositions of the present disclosure on porous substrates to result in porous substrates of the present disclosure. The composition includes a matrix. The matrix includes a plurality of active particles and a plurality of PTFE fibrils formed from PTFE resin. In some embodiments, the composition further includes free active particles, free PTFE fibrils, or both.

The method 200 optionally includes aerating an emulsion to form an aerated emulsion at optional step 210. An emulsion or mixture that has been aerated is characterized by the presence of air bubbles and/or air pockets. For example, an aerated emulsion may be characterized as having bubbles on the surface. Aeration may be accomplished using a variety of techniques such as mechanical shaking, gas injection, bottom-up bubbling, or combinations thereof.

The emulsion (210c) includes PTFE resin, a dispersant, and a surfactant. The surfactant may be any surfactant as described elsewhere herein. The dispersant may be any dispersant as described elsewhere herein. The aerated emulsion (201c) includes the PTFE resin, the dispersant, and a surfactant.

In some embodiments, the method 200 optionally includes forming the emulsion by diluting a concentrated mixture to form the emulsion (not depicted in FIG. 6). The concentrated mixture may include an emulsion of PTFE resin and the dispersant. In some embodiments, the concentrated mixture includes at least a portion of the surfactant. In some embodiments, the concentrated mixture includes 60 wt-% PTFE resin (e.g., 60 wt-% short-strand PTFE resin) based on the total weight of the concentrated mixture. In some embodiments, the concentrated mixture is diluted with a dispersant. In some embodiments, the concentrated mixture is diluted with a solution that includes a dispersant and a surfactant. The surfactant may be the same surfactant as in the emulsion or a different surfactant.

The method 200 optionally includes aerating the matrix pre-mixture to form an aerated matrix pre-mixture at optional step 230. Aeration may be accomplished through any means discussed elsewhere herein. The aerated matrix pre-mixture (230c) includes the PTFE resin, the dispersant, the surfactant, and the solid particulate composition.

The first illustrative method 200 optionally includes adding a solid particulate composition to the aerated emulsion to form a matrix pre-mixture at optional step 220. The matrix pre-mixture (220c) includes the PTFE resin, the surfactant, the solid particulate composition, and the dispersant. The solid particulate composition comprises a solid particulate. In some embodiments, the solid particulate composition comprises 100 wt-% of the solid particulate (i.e., no other components are included in the solid particulate composition). In other embodiments the solid particulate composition comprises a solid particulate and a liquid carrier. The liquid carrier may include water, one or more organic solvents (e.g., ethyl acetate, ethanol, methanol, isopropanol, butanol, dichloromethane, toluene, acetonitrile, acetone, diethyl ether, amyl alcohol, or tetrahydrofuran); or both. In some such embodiments, the solid particulate in the solid particulate composition is dissolved in the liquid carrier. In other embodiments, the solid particulate of the solid particulate composition is suspended in the liquid carrier. In yet other embodiments, a first portion of the solid particulate is dissolved in the liquid carrier and a second portion of the solid particulate is suspended in the liquid carrier.

The plurality of active particles includes at least a portion of the solid particulate. In embodiments where the composition includes free active particles, the free active particles include at least a portion of the solid particulate. In some embodiments, the solid particulate may be already in the form of the plurality of active particles and/or free active particles (if present). In some embodiments, the solid particulate is not in the form of the plurality of active particles and/or free active particles (if present). In some such embodiments, at least a portion of the solid particulate becomes the plurality of active particles and/or the free active particles (if present) through aggregation and/or precipitation of the solid particulate. For example, in some embodiments, at least a portion of the solid particulate is dissolved in the liquid carrier and throughout the method (e.g., during the drying step) the dissolved solid particulate become supersaturated and precipitates to form the plurality of active particles and/or free active particles (if present).

The amount of solid particulate (included in the solid particulate composition) may vary depending on the identity of the solid particulate and desired end application of the porous substrate. In some embodiments the aerated matrix pre-mixture includes 0.5 wt-% or greater, 10 wt-% or greater, 30 wt-% or greater, or 50 wt-% or greater of the solid particulate based on the total weight of the aerated matrix pre-mixture. In some embodiments, the aerated matrix pre-mixture includes 90 wt-% or less, 50 wt-% or less, 30 wt-% or less, or 10 wt-% or less of the solid particulate based on the total weight of the aerated matrix pre-mixture.

The method 200 includes contacting at least a portion of a porous substrate with the matrix pre-mixture or the aerated matrix pre-mixture at step 260. The porous substrate includes at least one major surface and a plurality of macro/micro pores coupled to the major surface (260c). In some embodiments, the porous substrate is a wettable porous substrate. The substrate is contacted with the matrix pre-mixture or the aerated matrix pre-mixture in a fashion to expose at least a portion of a major surface of the porous substrate and at least a portion of the plurality of macro/micro pores to the matrix pre-mixture or the aerated matrix pre-mixture. Contacting may be in the form of submerging at least a portion of the porous substrate in the matrix pre-mixture or the aerated matrix pre-mixture; pumping the matrix pre-mixture or the aerated matrix pre-mixture around at least a portion of the porous substrate; spraying aerosolized matrix pre-mixture of aerated matrix pre-mixture on at least a portion of the porous substrate; or combinations thereof.

The method 200 further includes allowing a hydrated composition to be disposed on the porous substrate. The hydrated composition includes the matrix, any other composition components (if included), at least a portion of the dispersant, at least a portion of the liquid carrier (if present), at least a portion of the wetting liquid (if present), and at least a portion of the surfactant. The plurality of active particles of the matrix includes at least a portion of the solid particulate. In some embodiments, the hydrated composition may include free active particles, free PTFE fibrils, or both. The hydrated composition may be disposed on at least a portion of at least one major surface of the substrate, impregnate at least a portion of the plurality of macro/micro pores coupled to the at least one major surface, be intercalated within the collapsible pores of the substrate, or any combination thereof. In some embodiments where the porous substrate is a wettable porous substrate, collapsible pores may be exposed through contacting the wettable porous substrate with a wettable liquid prior to contacting the wettable porous substrate with the aerated matrix pre-mixture. In some embodiments where the porous substrate is a wettable porous substrate, the collapsible pores may be exposed through contacting the porous substrate with the aerated matrix pre-mixture (e.g., the aerated matrix-premixture includes the wetting liquid).

In some embodiments, allowing a hydrated composition to be disposed on the porous substrate further incudes mixing the matrix pre-mixture or the aerated matrix pre-mixture while in contact with the at least a portion of the substrate such that at least a portion of a hydrated composition is disposed on the substrate at step 240.

Mixing may be accomplished through a variety of techniques including, mechanical rotation (e.g., on a rotating table), mechanical agitation, immersion blending, vibrational agitation, ultrasonic agitation, or combinations thereof. In some embodiments, it may be desirable to use a mixing technique that does not include shearing forces. Using a mixing technique that does not include shearing forces may result in less fibrilization of the PTFE fibrils. Mixing may allow for the fibrilization (elongation) of the PTFE resin into PTFE fibrils as well as the emulsification of the PTFE resin. Mixing may allow for the active particles to become homogenized within the aerated matrix pre-mixture and to form a catenated structures and/or conglomerated structures with the fibrilized and/or fibrilizing PTFE fibrils.

The mixing time may vary depending on the desired application of the porous substrate and/or the identity and/or amount of each component (e.g., the PTFE resin, the surfactant, the solid particulate) in the aerated matrix pre-mixture. The mixing time may be 10 minutes or greater, 1 hour or greater, 3 hours or greater, or 24 hours or greater. The mixing time may be 48 hours or less, 24 hours or less, 3 hours or less, or 1 hour or less. In some embodiments, the mixing time is 10 minutes to 3 hours, 1 hour to 3 hours, 1 hour to 24 hours, or 3 hours to 24 hours.

In some embodiments, the method 200 further includes contacting the at least a portion of the substrate with a wetting liquid at optional step 265. In some embodiments, the wetting liquid does not include a solid particulate. The wetting liquid may be any liquid capable of wetting the substrate; that is, swelling the substrate to expose collapsible pores in the solid portion of the substrate. In some embodiments, the wetting liquid is an organic solvent such as ethanol, methanol, acetone, or acetonitrile. In some embodiments, the wetting liquid is chosen such that at least one component of the solid particulate is not soluble therein. For example, in some embodiments where the solid particulate includes K₂CO₃, the wetting liquid may be ethanol. In other embodiments, the wetting liquid is chosen such that at least one component of the solid particulate is soluble (and dissolves) in the wetting liquid. In some embodiments, the wetting liquid has the same identity as the liquid carrier of the solid particulate composition (if a liquid carrier is used). In some embodiments, the wetting liquid is different than the liquid carrier of the solid particulate composition (if a liquid carrier is used).

The amount of substrate-wetting liquid contact time may vary. In some embodiments, the substrate-wetting liquid contact time is ten seconds or greater, 30 seconds or greater, one minute or greater, 5 minutes or greater, 1 hour or greater, 24 hours or greater. In some embodiments, the substrate-wetting liquid contact time is 48 hours or less, 24 hours or less, 1 hour or less, 5 minutes or less, 1 minute or less, or 30 seconds or less. Without wishing to be bound by theory, it is thought that contacting the at least a portion of the substrate with a wetting liquid allows for the porous substrate to swell exposing collapsible pores. The wetting liquid allows at least a portion of the composition or at least a portion of one or more components of the composition to migrate into the collapsible pores of the substrate. Upon drying, the collapsible pores at least partially collapse and the composition or components of the composition that were in the collapsible pores become embedded within the solid portion of the substrate. In some embodiments, the inclusion of the step of contacting the at least a portion of the substrate with the wetting liquid allows for a greater amount of the composition and/or components of the composition to impregnant the pores of the substrate and/or become embedded within the substrate than if the step was not included.

The first illustrative method 200 includes drying the hydrated composition to form the composition disposed on the porous substrate at step 250. Drying the hydrated composition includes removing at least a portion of the dispersant, at least a portion of the liquid carrier (if present), and at least a portion of the surfactant from the hydrated composition. After step 200, the porous substrate includes a first portion of the composition disposed on at least a portion of the major surface and at least a portion of the plurality of macro/micro pores impregnated with a second portion of the composition. In some embodiments, after step 200, the porous substrate further includes an embedded third portion of the composition (e.g., when the porous substrate is a wettable porous substrate, and a wetting liquid was used).

Drying may be accomplished to varying extents (i.e., amount of dispersant, liquid carrier, and/or surfactant may be present in the porous substrate after drying the hydrated composition) and include various techniques such as those discussed herein (e.g., see the discussion about FIG. 8).

In some embodiments where the substrate was contacted with a wetting liquid (step 265) and at least a portion of the solid particulate dissolved in the wetting liquid, drying the hydrated composition may further include precipitating at least a portion of the solid particulate to from free active particles. Some such free active particles may be embedded within the solid portion of the substrate.

In some embodiments of the first illustrative method 200, the plurality of PTFE fibrils of the matrix include short-strand PTFE fibrils formed from short-strand PTFE resin and long-strand PTFE fibrils formed from long-strand PTFE resin. In such embodiments, the PTFE resin of the matrix pre-mixture and/or the aerated matrix pre-mixture include short-strand PTFE resin and long-strand PTFE resin. The PTFE resin of the aerated emulsion includes short-strand PTFE resin. The long-strand PTFE resin may be added at any step, or multiple steps, of the method 200 such that the PTFE resin of one or more of the emulsion, aerated emulsion (210c), matrix pre-mixture (220c), or the aerated matrix pre-mixture (230c) include short-strand PTFE resin and long-strand PTFE resin. For example, in some embodiments, the method 200 further includes adding long-strand PTFE resin to the emulsion such that the PTFE resin of the emulsion, the PTFE resin of the aerated emulsion (210c), the PTFE resin of the pre-mixture (220c), and the PTFE resin of the aerated pre-mixture (230c) include short-strand PTFE resin and long-strand PTFE resin. In some embodiments, method 200 further includes adding long-strand PTFE resin to the aerated emulsion such that the PTFE resin of the aerated emulsion (210c), the PTFE resin of the pre-mixture (220c), and the PTFE resin of the aerated pre-mixture (230c) include short-strand PTFE resin and long-strand PTFE resin. In some embodiments, method 200 further includes adding long-strand PTFE resin to the matrix pre-mixture such that the PTFE resin of the matrix pre-mixture (220c) and the PTFE resin of the aerated pre-mixture (230c) include short-strand PTFE resin and long-strand PTFE resin. In some embodiments, method 200 further includes adding long-strand PTFE resin to the aerated matrix pre-mixture such that the PTFE resin of the aerated matrix pre-mixture (230c) includes short-strand PTFE resin and long-strand PTFE resin.

In some embodiments of the method 200, the matrix pre-mixture and/or the aerated matrix pre-mixture includes 0.01 wt-% or greater, 15 wt-% or greater, 25 wt-% or greater, 45 wt-% or greater, 55 wt-% or greater, or 65 wt-% or greater of the PTFE resin based on the total weight of the matrix pre-mixture or aerated matrix pre-mixture. In some embodiments of the method 200, the matrix pre-mixture and/or the aerated matrix pre-mixture includes 80 wt-% or less, 65 wt-% or less, 55 wt-% or less, 45 wt-% or less, 25 wt-% or less, or 15 wt-% or less of the PTFE resin based on the total weight of the matrix pre-mixture or the aerated matrix pre-mixture.

In some embodiments of the method 200, the matrix pre-mixture and/or the aerated matrix pre-mixture includes 0.01 wt-% or greater, 1 wt-% or greater, 5 wt-% or greater, or 10 wt-% or greater, of the long-strand PTFE resin based on the total weight of the matrix pre-mixture or the aerated matrix pre-mixture. In some embodiments of the method 200, the matrix pre-mixture and/or the aerated matrix pre-mixture includes 15 wt-% or less, 10 wt-% or less, 5 wt-% or less, or 1 wt-% or less of the long-strand PTFE resin based on the total weight of the matrix pre-mixture or aerated matrix pre-mixture.

In some embodiments of the method 200, the matrix pre-mixture and/or the aerated matrix pre-mixture includes 0.1 wt-% or greater, 5 wt-% or greater, 15 wt-% or greater, 25 wt-% or greater, 45 wt-% or greater, or 55 wt-% or greater of the short-strand PTFE based on the total weight of the matrix pre-mixture or the aerated matrix pre-mixture. In some embodiments of the method 200, the matrix pre-mixture and/or the aerated matrix pre-mixture includes 70 wt-% or less, 55 wt-% or less, 45 wt-% or less, 25 wt-% or less, 15 wt-% or less, or 5 wt-% or less of the short-strand PTFE resin based on the total weight of the matrix pre-mixture or the aerated matrix pre-mixture.

FIG. 7 is a flow diagram outlining a second illustrative method for disposing the compositions of the present disclosure on porous substrates to result in the porous substrates of the present disclosure. The composition includes a matrix. The matrix includes a plurality of active particles and a plurality of PTFE fibrils formed from a plurality of PTFE resin. In some embodiments, the composition further includes free active particles, free PTFE fibrils, or both. The porous substrate includes a major surface and a plurality of macro/micro pores coupled to the major surface. In some embodiments, the porous substrate is a wettable porous substrate. In some such embodiments, a plurality of collapsible pores are exposed during one or more steps of the method 400.

In some embodiments, the method 400 optionally includes forming a matrix pre-mixture at optional step 460A. The matrix pre-mixture (460c(A)) includes PTFE resin, a surfactant, and a dispersant. In some embodiments, the matrix pre-mixture is formed by diluting a concentrated matrix pre-mixture with the dispersant or a solution that includes the dispersant and the surfactant at step 460B. The concentrated matrix pre-mixture (460c(B)) includes the PTFE resin and the dispersant. In some embodiments, the concentrated matrix pre-mixture and the matrix pre-mixture include an emulsion that include PTFE resin and the dispersant. In some embodiments, the concentrated matrix pre-mixture includes at least a portion of the surfactant. In some embodiments, the concentrated matrix pre-mixture includes an emulsion of 60 wt-% PTFE resin (e.g., 60 wt-% short-strand PTFE resin) based on the total weight of the concentrated matrix pre-mixture.

In some embodiments, the method 400 optionally includes aerating the matrix pre-mixture to form an aerated matrix pre-mixture at optional step 450. The matrix pre-mixture (450c) includes the PTFE resin, the surfactant, and the dispersant. Aeration may be accomplished using any technique as disclosed herein.

The method 400 includes contacting at least a portion of a substrate with the matrix pre-mixture or the aerated matrix pre-mixture at step 410. The aerated matrix pre-mixture is a matrix pre-mixture that has been aerated (e.g., such as at optional step 450). In some embodiments, it may be desirable to contact at least a portion of a substrate with a matrix pre-mixture that has not been aerated (i.e., a matrix pre-mixture). In other embodiments, it may be desirable to contact at least a portion of a substrate with a matrix pre-mixture that has been aerated (i.e., an aerated matrix pre-mixture). The substrate is contacted with the aerated matrix pre-mixture or matrix pre-mixture in a fashion to expose at least a portion of a major surface of the porous substrate and at least a portion of the plurality of macro/micro pores coupled to the major surface to the aerated matrix pre-mixture or the matrix pre-mixture. Contacting may be accomplished using any suitable technique as described herein.

The contact time may vary. In some embodiments, the contact time is ten seconds or greater, 30 seconds or greater, one minute or greater, 5 minutes or greater, 1 hour or greater, or 24 hours or greater. In some embodiments, contact time is 48 hours or less, 24 hours or less, 1 hour or less, or 5 minutes or less, 1 minute or less, or 30 seconds or less.

The method 400 includes contacting the at least a portion of the substrate with a solid particulate composition. The solid particulate composition includes a solid particulate. In some embodiments, the solid particulate composition includes a solid particulate and a liquid carrier. In some embodiments where the porous substrate is a wettable porous substrate, the liquid carrier includes a wetting liquid. In such embodiments, the wetting liquid exposes a plurality of collapsible pores of the wettable porous substrate. The liquid carrier may include water; an organic solvent such as ethyl acetate, ethanol, methanol, isopropanol, butanol, dichloromethane, toluene, acetonitrile, acetone, diethyl ether, amyl alcohol, tetrahydrofuran; or combinations thereof.

The solid particulate may include one or more species to form one or more different types of active particles (e.g., activated carbon and a potassium carbonate). In some such embodiments, at least one component and/or at least a portion of the solid particulate in the solid particulate composition is dissolved in the liquid carrier (e.g., a wetting liquid). In other embodiments, the solid particulate of the solid composition is suspended in the liquid carrier. In yet other embodiments, a first portion of the solid particulate is dissolved in the liquid carrier and a second portion of the solid particulate is suspended in the liquid carrier. For example, the solid particulate composition may include a first chemical species that is dissolved in the liquid carrier and a second chemical species that is suspended in the liquid carrier.

At least a portion of the first plurality of active particles, at least a portion of the free active particles (if present), or both, include at least a portion of the solid particulate. In embodiments, the at least a portion of the substrate is contacted with the solid particulate composition that does not include a liquid carrier; that is, the solid particulate composition includes 100 wt-% of the solid particulate. In some such embodiments, contacting may be accomplished by disposing the solid particulate on the at least a portion of the substrate. In other embodiments, the solid particulate composition includes the solid particulate and a liquid carrier. In such embodiments, contacting the at least a portion of the substrate with the solid particulate composition may be accomplished using any suitable technique as described herein.

In embodiments where the solid particulate composition includes a liquid carrier, the solid particulate composition includes 0.5 wt-% or greater, 10 wt-% or greater, or 30 wt-% or greater, or 50 wt-% or greater of the solid particulate based on the total weight of the solid particulate composition. In embodiments where the solid particulate composition includes a liquid carrier, the solid particulate composition includes 90 wt-% or less, 50 wt-% or less, 30 wt-% or less, or 10 wt-% or less of the solid particulate based on the total weight of the solid particulate composition.

The amount of substrate-solid particulate composition contact time may vary. In some embodiments, the substrate-solid particulate composition contact time is ten seconds or greater, 30 seconds or greater, one minute or greater, 5 minutes or greater, 1 hour or greater, 24 hours or greater. In some embodiments, the substrate-solid particulate composition contact time is 48 hours or less, 24 hours or less, 1 hour or less, 5 minutes or less, 1 minute or less, or 30 seconds or less.

In some embodiments, the step of contacting at least a portion of a substrate with a matrix pre-mixture or an aerated matrix pre-mixture is performed prior to the step of contacting the at least a portion of the substrate with the solid particulate composition(i.e., step 410 is performed before step 420). In some embodiments, the step of contacting at least a portion of the substrate with a solid particulate composition is performed prior to the step of contacting the at least a portion of a substrate with a matrix pre-mixture or an aerated matrix pre-mixture (i.e., step 420 is performed before step 410). Generally, the at least a portion of the substrate is saturated with (e.g., still in contact with) the matrix pre-mixture, aerated matrix pre-mixture, or solid particulate composition when the substrate is then contacted with the matrix pre-mixture, aerated matrix pre-mixture, or solid particulate. For example, at least a portion of a substrate may be contacted with a bulk amount of a matrix pre-mixture, aerated matrix pre-mixture, or solid particulate composition; then, the substrate is removed from the bulk amount of the matrix pre-mixture, aerated matrix pre-mixture, or solid particulate composition. Due to the absorbent/adsorbent characteristics of some substrates, a portion of the bulk amount of the matrix pre-mixture, aerated matrix pre-mixture, or solid particulate composition may have adsorbed/absorbed onto the surface of the substrate and/or absorbed/adsorbed into the pores (e.g., macro/micro pores and/or collapsible pores) of the substrate. As such, the at least a portion of the substrate is in contact with the matrix pre-mixture, aerated matrix pre-mixture, or solid particulate composition during a subsequent contact step. For example, in some embodiments, at least a portion of a substrate is submerged in a bulk amount of a matrix pre-mixture or aerated matrix pre-mixture; removed from the bulk amount of the matrix pre-mixture or aerated matrix pre-mixture; and then contacted with a bulk amount of a solid particulate composition while the at least a portion of the substrate is saturated with a portion of the bulk amount of the matrix pre-mixture or the aerated matrix pre-mixture. In some embodiments, at least a portion of a substrate is contacted with a bulk amount of the solid particulate composition; removed from the bulk amount of the solid particulate composition; and then contacted with a bulk amount of a matrix pre-mixture or aerated matrix pre-mixture while the at least a portion of the substrate is saturated with a portion of the bulk amount of the solid particulate composition.

In some embodiments, the step of contacting at least a portion of a substrate with a matrix pre-mixture or an aerated matrix pre-mixture (step 410) is performed at the same time as the step of contacting the at least a portion of the substrate with the solid particulate composition (step 420). That is, the at least a portion of the substrate is contacted with a bulk amount of a matrix pre-mixture or aerated matrix pre-mixture at the same time the at least a portion of the substrate is contacted with a bulk amount of a solid particulate composition. For example, at least a portion of a substrate may first be submerged in a bulk amount of the matrix pre-mixture or the aerated matrix pre-mixture; then, a bulk amount of a solid particulate composition may be pumped up, through, or around the at least a portion of the substrate while the at least a portion of the substrate is still submerged in the bulk amount of the matrix pre-mixture or aerated matrix pre-mixture. In some embodiments, at least a portion of a substrate may first be submerged in a bulk amount of a solid particulate composition; then, a bulk amount of a matrix pre-mixture or an aerated matrix pre-mixture may be pumped up, through, or around the at least a portion of the substrate while the at least a portion of the substrate is still submerged in the bulk amount of the solid particulate composition.

Without wishing to be bound by theory, it is thought that contacting the substrate with the solid particulate composition may allow for the free active particles (if present) to become embedded within at least a portion of the plurality of collapsible pores of the substrate. It is also thought that contacting the substrate with the solid particulate composition allows for increased adhesion between the composition and the substrate. Further, it is thought that contacting the substrate with the solid particulate composition may allow for higher capacity towards the absorption of acidic- or basic-gases since a greater amount of the chemically active adsorbent is immobilized within the substrate than would be possible via impregnating the chemisorbent onto a support followed by loading the hybrid material onto the substrate.

In some embodiments, the steps of contacting at least a portion of a substrate with a matrix pre-mixture or aerated matrix pre-mixture (step 410) and contacting the at least a portion of the substrate with a solid particulate composition (step 420) may be repeated as a sequence, or as individual steps multiple times (e.g., 2 times, 3 times, 4 times, etc.). For example, at least a portion of a substrate may be contacted with a matrix pre-mixture or an aerated matrix pre-mixture, contacted with a solid particulate composition, and then contacted with the matrix pre-mixture or the aerated matrix pre-mixture a second time. In other embodiments, at least a portion of a substrate may be contacted with a matrix pre-mixture or an aerated matrix pre-mixture, contacted with a first solid particulate composition, and contacted with the first solid particulate composition a second time or with a second solid particulate composition, a third solid particulate composition, and so on. In some such embodiments, the composition of the first solid particulate composition is different than that of the first solid particulate composition. In some embodiments, the composition of the second solid particulate composition is the same as that of the first solid particulate composition.

In some embodiments, the matrix pre-mixture or the aerated matrix pre-mixture of the method 400 further includes a second solid particulate (i.e., the solid particulate in the solid particulate composition is the first solid particulate). The amount of the second solid particulate may vary depending on the identity of the second solid particulate and desired end application of the porous substrate. In some embodiments the matrix pre-mixture or the aerated matrix pre-mixture include 0.5 wt-% or greater, 10 wt-% or greater, or 30 wt-% or greater of the second solid particulate based on the total weight of the matrix pre-mixture or the aerated matrix pre-mixture. In some embodiments, the matrix pre-mixture or the aerated matrix pre-mixture comprise 50 wt-% or less, 30 wt-% or less, or 10 wt-% or less of the second solid particulate based on the total weight of the matrix pre-mixture or the aerated matrix pre-mixture. The plurality of active particles, the free active particles, or both may include a portion of the second solid particulate.

In some embodiments, the first solid particulate and the second solid particulate are made of the same material. In some embodiments, the first solid particulate and the second solid particulate are made of different materials.

In some embodiments, the method 400 further includes contacting the at least a portion of the substrate with a wetting liquid at optional step 425. The wetting liquid may be any liquid capable of wetting the substrate; that is, swelling the substrate to expose collapsible pores in the solid portion of the substrate. In some embodiments, the wetting liquid is an organic solvent such as ethanol, methanol, acetone, or acetonitrile. In some embodiments, the wetting liquid is chosen such that at least one component of the solid particulate is not soluble therein. For example, in some embodiments where the solid particulate includes K₂CO₃, the wetting liquid may be ethanol. In some embodiments, the wetting liquid has the same identity as the liquid carrier of the solid particulate composition (if a liquid carrier is used). In some embodiments, the wetting liquid is different than the liquid carrier of the solid particulate composition (if a liquid carrier is used).

In some embodiments, step 425 is done after the completion of steps 410 and 420 (which may be conducted in either order). In some such embodiments, the order of the steps is step 410, step 420, and then step 425. In other such embodiments, the order of steps is step 420, step 310 and then step 425. In some embodiments, step 425 is done after the completion of one of steps 410 or 420 but before completion of the step not yet completed. In some embodiments, the at least a portion of the substrate may be contacted with the same wetting liquid or one or more different wetting liquids before and/or after completion of other steps of the method (e.g., step 420 and step 410).

The amount of substrate-wetting liquid contact time may vary. In some embodiments, the substrate-wetting liquid contact time is ten seconds or greater, 30 seconds or greater, one minute or greater, 5 minutes or greater, 1 hour or greater, 24 hours or greater. In some embodiments, the substrate-wetting liquid contact time is 48 hours or less, 24 hours or less, 1 hour or less, 5 minutes or less, 1 minute or less, or 30 seconds or less.

Without wishing to be bound by theory, it is thought that contacting the at least a portion of the substrate with a wetting liquid allows for the porous substrate to swell exposing collapsible pores. The wetting liquid allows at least a portion of the composition or at least a portion of one or more components of the composition to migrate into the collapsible pores of the substrate. Upon drying, the collapsible pores at least partially collapse and the composition or components of the composition that were in the collapsible pores become embedded within the solid portion of the substrate. In some embodiments, the inclusion of the step of contacting the at least a portion of the substrate with the wetting liquid allows for a greater amount of the composition and/or components of the composition to impregnant the pores of the substrate and/or become embedded within the substrate than if the step was not included.

The method 400 includes allowing a hydrated composition to be disposed on the porous substrate at step 430. The hydrated composition includes the matrix, the free active particles (if present), the free PTFE fibrils (if present), at least a portion of the dispersant, at least a portion of the liquid carrier (if present), at least a portion of the wetting liquid (if present), and at least a portion of the surfactant. The hydrated composition may be disposed on at least a portion of at least one major surface of the substrate, impregnate at least a portion of the plurality of macro/micro pores of a substrate, be intercalated within the collapsible pores of the substrate, or any combination thereof.

The method 400 includes drying the hydrated composition to form the composition disposed on the porous substrate. Drying the hydrated composition includes removing at least a portion of the dispersant, at least a portion of the liquid carrier (if present), and at least a portion of the surfactant from the hydrated composition. Drying may be accomplished to varying extents (i.e., the amount of dispersant, liquid carrier, and/or surfactant present in the porous substrate after drying) and include various techniques such as those discussed herein (e.g., see the discussion about FIG. 8).

In some embodiments where the substrate solid particulate composition included a solid particulate component and/or a portion of the solid particle dissolved in the liquid carrier and/or the substrate was contacted with a wetting liquid that included a wetting liquid capable of dissolving a component of a portion of the solid particulate, drying the hydrated composition may further include precipitating at least a portion of the solid particulate to from free active particles. Some such free active particles may be embedded within the solid portion of the substrate.

In some embodiments of method 400, the plurality of PTFE fibrils of the matrix include short-strand PTFE fibrils formed from short-strand PTFE resin and long-strand PTFE fibrils formed from long-strand PTFE resin. In such embodiments, the PTFE resin of the aerated matrix pre-mixture (410c) or matrix pre-mixture (410c) include short-strand PTFE resin and long-strand PTFE resin. The PTFE resin of the concentrated matrix pre-mixture mixture include short-strand PTFE. The long-strand PTFE resin may be added at any step, or multiple steps, of the method 400 such that the PTFE resin of one or more of the concentrated matrix pre-mixture (460c(B)), the matrix pre-mixture (460c(A)), and the aerated matrix pre-mixture (450c) include short-strand PTFE resin and long-strand PTFE resin. For example, in some embodiments, the method 400 further includes adding long-strand PTFE resin to the concentrated matrix pre-mixture such that the PTFE resin of the concentrated matrix pre-mixture, the PTFE resin of the matrix pre-mixture (450c), and the PTFE resin of the aerated matrix pre-mixture (450c) include short-strand PTFE resin and long-strand PTFE resin. In some embodiments, the method 400 further includes adding long-strand PTFE resin to the matrix pre-mixture such that the PTFE resin of the pre-mixture (460c) and the PTFE resin of the aerated pre-mixture (450c) include short-strand PTFE resin and long-strand PTFE resin. In some embodiments, the method 400 further includes adding long-strand PTFE resin to the aerated matrix pre-mixture such that the PTFE resin of the aerated matrix pre-mixture (450c) include short-strand PTFE resin and long-strand PTFE resin.

In some embodiments of the method 400, the aerated matrix pre-mixture or the matrix pre-mixture include 0.01 wt-% or greater, 15 wt-% or greater, 25 wt-% or greater, 45 wt-% or greater 55 wt-% or greater, or 65 wt-% or greater of the PTFE resin based on the total weight of the aerated matrix pre-mixture or the matrix pre-mixture. In some embodiments of the method 400, the aerated matrix pre-mixture or the matrix pre-mixture include 80 wt-% or less, 65 wt-% or less, 55 wt-% or less, 45 wt-% or less, 25 wt-% or less, or 15 wt-% or less of the PTFE resin based on the total weight of the aerated matrix pre-mixture or the matrix pre-mixture.

In some embodiments of the method 400, the aerated matrix pre-mixture or the matrix pre-mixture include 0.01 wt-% or greater, 1 wt-% or greater, 5 wt-% or greater, or 10 wt-% or greater, of the long-strand PTFE resin based on the total weight of the aerated matrix pre-mixture or the matrix pre-mixture. In some embodiments of the method 400, the aerated matrix pre-mixture or the matrix pre-mixture includes 15 wt-% or less, 10 wt-% or less, 5 wt-% or less, or 1 wt-% or less of the long-strand PTFE resin based on the total weight of the aerated matrix pre-mixture or the matrix pre-mixture.

In some embodiments of the method 400, the aerated matrix pre-mixture or the matrix pre-mixture includes 0.1 wt-% or greater, 5 wt-% or greater, 15 wt-% or greater, 25 wt-% or greater, 45 wt-% or greater, or 55 wt-% or greater of the short-strand PTFE based on the total weight of the aerated matrix pre-mixture or the matrix pre-mixture. In some embodiments of the method 400, the aerated matrix pre-mixture or the matrix pre-mixture includes 80 wt-% or less, 55 wt-% or less, 45 wt-% or less, 25 wt-% or less, 15 wt-% or less, or 5 wt-% or less of the short-strand PTFE resin based on the total weight of the aerated matrix pre-mixture or the matrix pre-mixture.

At any time during anyone of the methods of the present disclosure, a dispersant may be added to the components of a concentrated matrix pre-mixture, an aerated emulsion, a matrix pre-mixture, an aerated matrix pre-mixture, or combinations thereof. In some embodiments, a dispersant may be added before or during a step of any one of the methods disclosed herein. For example, in embodiments where long-strand PTFE resin are added to a concentrated matrix pre-mixture, an emulsion, an aerated emulsion, a matrix pre-mixture, an aerated matrix pre-mixture, the long-strand PTFE resin may be added in a mixture that includes a dispersant. A dispersant may be added to dilute the components, suspend the components, facilitate the formation of a colloid that includes one or more components, facilitate the formation of an emulsion, facilitate aeration, or combinations thereof. For example, in some embodiments, a dispersant may be added to the aerated emulsion (e.g., 210c). In some embodiments, a dispersant may be added to the matrix pre-mixture (e.g., 220c and 460c). In some embodiments, a dispersant may be added to the aerated matrix-pre-mixture (e.g., 230c and 450c). In some embodiments, a dispersant may be added to the mixture. In some embodiments, a dispersant may be added to the emulsion (e.g., 210c).

Methods of the present disclosure include drying the hydrated composition to form the composition disposed on the pours substrate. Drying the hydrated composition includes removing at least a portion of the dispersant and/or liquid carrier (if present) from the hydrated composition. Drying the hydrated composition also includes removing at least a portion of the surfactant from the hydrated composition. A porous substrate formed after drying a hydrated composition includes 50 wt-% or less, 20 wt-% or less, 10 wt-% or less, 5 wt-% or less, or 1 wt-% or less dispersant and/or liquid carrier (if present) based on the total weight of the porous substrate. A porous substrate formed after drying a hydrated composition includes 50 wt-% or less, 20 wt-% or less, 10 wt-% or less, 5 wt-% or less, or 1 wt-% or less surfactant based on the total weight of the porous substrate. The extent of drying may vary depending on the desired application and/or next processing steps of the porous substrate.

The dispersant of any one of the illustrative methods may be water, one or more organic solvents, or both. In some embodiments, the dispersant includes water. In some embodiments, the dispersant includes an organic solvent or a mixture of organic solvents. Examples of organic solvent that may be included in a dispersant include, methanol, acetone, tetrahydrofuran, dimethylformamide, acetonitrile, isopropanol, ethanol, or combinations thereof.

FIG. 8 is a flow diagram outlining various drying techniques and/or drying method steps. In some embodiments, the hydrated composition is formed such that it is contacting a solution of excess dispersant, liquid carrier (if present), and surfactant; that is, the hydrated composition crashed out of the aerated matrix pre-mixture, matrix pre-mixture, or solid particulate composition. In such embodiments, drying the hydrated composition includes separating the hydrated composition from the remaining aerated matrix pre-mixture, matrix pre-mixture, or solid particulate composition at step 500. This may be accomplished by decanting the aerated matrix pre-mixture, matrix pre-mixture, or solid particulate composition; or physically removing the hydrated composition from the aerated matrix pre-mixture, matrix pre-mixture, or solid particulate composition.

In some embodiments, drying the hydrated composition includes contacting at least a portion of the hydrated composition (e.g., the portion of the major surface of the porous substrate having the hydrated composition disposed thereon), preferably the entire hydrated composition, with an absorbent material. The absorbent material may draw at least a portion of the dispersant, at least a portion of the surfactant, and at least a portion of the liquid carrier (if present) out of the hydrated composition. Any suitable absorbent material may be used. Examples of absorbent materials include cotton; cellulose; a sponge including polyester, polyurethane, vegetal cellulose, melamine, or combinations thereof; anhydrous calcium chloride; anhydrous magnesium sulfate; sodium polyacrylate; and combinations thereof. The hydrated composition may be in contact with the absorbent material for a time. In some embodiments, the contact time is 1 second or greater, 1 minute or greater, or 1 hour or greater. In some embodiments, the contact time is 24 hours or less, 1 hour or less, or 1 min or less. In such embodiments, the method further includes removing at least a portion, preferably all, of the absorbent material from the hydrated composition at step 520.

In some embodiments the hydrated composition is contacted with an absorbent material more than once. Said differently, in some embodiments, the step of contacting at least a portion of the hydrated composition with the absorbent (step 510) and the step of removing at least a portion of the absorbent material from the hydrated composition (step 520) are consecutively repeated a number of times (e.g., 2 to 10 times, 2 to 20 times, or 2 to 50 times), each time using an absorbent material that had not been previously contacted with the hydrated composition (i.e., a fresh absorbent material).

In some embodiments, drying the hydrated composition further includes exposing the hydrated composition to an elevated temperature for a period of time at step 540. In some embodiments, the hydrated composition is exposed to a temperature of 100° C. to 400° C., preferably 100° C. to 300° C. for 0.1 hour to 24 hours, preferably 1 hour to 5 hours. Preferably, the hydrated composition is not subjected to calcinating conditions. PTFE fibrils may contract at calcinating conditions (e.g., temperatures above 330° C.) which may manifest as broken PTFE fibrils and reduced mechanical stability of the matrix.

In some embodiments, drying the hydrated composition to form the matrix further comprises applying a vacuum to the hydrated composition. In some such embodiments, the hydrated composition is simultaneously exposed to an elevated temperature (e.g., 25° C. to 150° C.).

The surfactant of anyone of the illustrative methods may be a nonionic nonfluorinated surfactant. A nonionic surfactant is a surfactant that has a polar head group that is not charged. Examples of nonionic nonfluorinated surfactants that may be used include ethoxylates, alkoxylates, and cocamides. In some embodiments the surfactant is polyethylene glycol trimethylnonyl ether. In some embodiments, the aerated matrix pre-mixture and/or the matrix pre-mixture includes 0.5 wt-% or greater, 5 wt-% or greater, or 20 wt-% or greater of the surfactant based on the total weight of the aerated matrix pre-mixture or the matrix pre-mixture. In some embodiments, the aerated matrix pre-mixture and/or matrix pre-mixture includes 40 wt-% or less, 20 wt-% or less, or 5 wt-% or less of the surfactant based on the total weight of the aerated matrix pre-mixture or the matrix pre-mixture The aerated matrix pre-mixture or the matrix pre-mixture of any one of the illustrative methods may include 0.5 wt-% to 40 wt-%, preferably 5 wt-% to 20 wt-% of the surfactant based on the total weight of the aerated matrix pre-mixture or the matrix pre-mixture.

The methods of the present disclosure may result in a variety of loading capacities of the plurality of active particles. The loading capacity for each solid particulate (or any individual component of a solid particulate) may be calculated according to the Composition Analysis Test Method (i.e., Loading Capacity Test). The sum of the loading capacity for each component of a solid particulate is considered the loading capacity for the plurality of active particles that include the components of the solid particulate. For example, if a solid particulate includes activated carbon, the loading capacity of the activated carbon is the loading capacity of the plurality of active particles that include the activated carbon. If a solid particulate included manganese oxide and copper oxide, the loading capacity of the plurality of active particles that includes the manganese oxide and copper oxide is the sum of the loading capacity of the manganese oxide and the loading capacity of the copper oxide.

The total active particle loading capacity is the sum of the loading capacity of the one or more components making up the plurality of active particles and the free active particles (if present). For example, in embodiments plurality of active particles and the free active particles (if present) include manganese oxide and copper oxide, the total active particle loading capacity is the sum of the loading capacity of the manganese oxide and copper oxide. In some embodiments, the methods of the present disclosure result in a total active particle loading capacity that is 50 wt-% or greater, 70 wt-% or greater, 80 wt-% or greater, or 90 wt-% or greater. In some embodiments, the methods of the present disclosure result in a plurality of active particle loading capacity that is 95 wt-% or less, 90 wt-% or less, 80 wt-% or less, or 70 wt-% or less.

### EXEMPLARY EMBODIMENTS

Throughout the exemplary embodiments, it is understood that the term “macro/micro pores” refers to macro pores or a plurality of macro pores, micro pores or a plurality of micro pores if present, or both.

### Porous Substrate Embodiments

Embodiment 1C is a porous substrate comprising a composition disposed thereon, the composition comprising a matrix, the matrix comprising a plurality of PTFE fibrils and a plurality of active particles. In some embodiments, the plurality of PTFE fibrils comprises short-strand PTFE fibrils and long-strand PTFE fibrils.

Embodiment 2C is the porous substrate of embodiment 1C, wherein the composition further comprises free active particles, free PTFE fibrils, or both. In some embodiments, the free PTFE fibrils comprise short-strand PTFE fibrils. In some embodiments, the plurality of active particles and the free active particles comprise a material that is the same. In other embodiments, the plurality of active particles and the free active particles comprise materials that are different.

Embodiment 3C is the porous substrate of embodiment 1C or 2C, wherein the porous substrate comprises a major surface and a plurality of macro pores coupled to the major surface; wherein a first portion of the composition is disposed on at least a portion of the major surface; and wherein at least a portion of the plurality of macro pores are impregnated with a second portion of the composition.

Embodiment 4C is the porous substrate of embodiment 3C, wherein the portion of the plurality of macro/micro pores comprises a first portion of macro/micro pores; wherein the first portion of macro/micro pores is impregnated with a first component of the composition; and wherein a second portion of macro/micro pores is impregnated with a second component of the composition.

Embodiment 5C is the porous substrate of embodiment 4C wherein the first component and the second component are the matrix, at least one particle of the free active particles, or at least one PTFE fibril of the free PTFE fibrils. In some embodiments, the first component is the matrix or composition as a whole, and the second component is at least one particle of the free active particles.

Embodiment 6C is the porous substrate of anyone of embodiments 1C through 5C, wherein the porous substrate is a wettable porous substrate.

Embodiment 7C is the porous substrate of embodiment 6C, wherein the porous substrate comprises a third portion of the composition embedded within the porous substrate (e.g., embedded within the solid portion of the porous substrate).

Embodiment 8C is the porous substrate of embodiment 7C, wherein the porous substrate comprises one or more components of the composition embedded within. The one or more components may be a portion of the matrix, at least one particle of the free active particles, at least one PTFE fibril of the free PTFE fibrils, or any combination thereof. In some embodiments, the one or more components comprise free PTFE fibrils. In some such embodiments, the free PTFE fibrils comprise long-strand PTFE fibrils.

Embodiment 9C is the porous substrate of any one of embodiments 1C through 8C, wherein the porous substrate is made from a material comprising a reticulated foam. The reticulated foam may be polymer-based; metal-, metal oxide-, or metal carbide-based; carbon-based; ceramic based; or any combination thereof. The reticulated foam may include reticulated polyester; reticulated polyether; reticulated polyurethane; reticulated polyurethane without heat treatment; reticulated cellulose; reticulated melamine; reticulated steal; reticulated activated carbon; reticulated vitreous carbon; reticulated graphene; reticulated foams made from metals such as reduced metals (such as titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof); reticulated silicon oxide; reticulated silicon carbide; or any combination thereof.

Embodiment 10C is the porous substrate of any one of embodiments 1C through 9C, wherein at least a portion of the plurality of active particles and at least a portion of the plurality of the PTFE fibrils adopt a catenated structure, a conglomerated structure, or both.

Embodiment 11C is the porous substrate of any one of embodiments 1C through 10C, wherein the short-strand PTFE fibrils, the long-strand PTFE fibrils, the free PTFE fibrils (if present), or any combination thereof comprise C3-PTFE, C2-PTFE, C1-PTFE, or combinations thereof.

Embodiment 12C is the porous substrate of any one of embodiments 1C through 11C, wherein the plurality of active particles, the free active particles (if present), or both, comprise a catalyst, an adsorbent, a growth seed, a metal-organic framework (MOF), an electroactive material, a bioactive material, or any combination thereof.

Embodiment 13C is the porous substrate of embodiment 12C, wherein the plurality of active particles comprises a catalyst; and wherein the catalyst is capable of ozone destruction.

Embodiment 14C is the porous substrate of embodiment 11C or 12C, wherein the plurality of active particles, the free active particles (if present), or both, comprise a catalyst; and wherein the catalyst is capable of nitrobenzene reduction, hydrogenation, NOx reduction, or combinations thereof.

Embodiment 15C is the composition of embodiment 13C, wherein the plurality of active particles comprises a catalyst; and wherein the catalyst comprises an iron silicate, an iron manganese silicate, a zinc iron silicate, or any combination thereof; a transition metal oxides such as zinc oxide, manganese oxide, copper oxide, cerium dioxide, or any combination thereof; a reduced metal (i.e., zero valent metal) that includes titanium, lead, iron, copper, zinc, chromium, cobalt, nickel, manganese, gold, silver, platinum, palladium, rhodium, tungsten, molybdenum, vanadium, zirconium, silicon, ruthenium, or any combination thereof; carbonates such as barium carbonate, magnesium carbonate, calcium carbonate, strontium carbonate, or any combination thereof; or any combination thereof.

Embodiment 16C is the porous substrate of embodiment 12C, wherein the plurality of active particles, the free active particles (if present), or both comprise an adsorbent; and wherein the adsorbent is a physisorbent, a chemisorbent, or a physisorbent-chemisorbent hybrid. In some embodiments the physisorbent-chemisorbent hybrid is a grafted hybrid or an impregnated hybrid.

Embodiment 17C is the porous substrate of embodiment 16C, wherein the plurality of active particles, the free active particles (if present), or both, comprise an adsorbent; and wherein the adsorbent is capable of adsorbing a basic compound, an acidic compound, an organic compound, an inorganic compound, or any combinations thereof. The acidic compound, basic compound, organic compound, inorganic compound, or any combination thereof may be in a liquid state, gaseous and/or vapor state (preferably), or both.

Embodiment 18C is the porous substrate of embodiment 17C, wherein the adsorbent is capable of adsorbing a basic compound. The basic compound may be in a liquid state, gaseous and/or vapor state (preferably), or both. In some such embodiments, the adsorbent includes an inorganic acid (e.g., boric acid, nitric acid, sulfuric acid, hydrochloric acid, hydrogen chloride, hydrogen fluoride, hydrogen bromide, phosphoric acid, perchloric acid, periodic acid, or any combination thereof) or a chemisorbent that includes a carboxylic acid functional (e.g., citric acid, terephthalic acid, trimesic acid, tartaric acid, maleic acid, benzoic acid, oxalic acid, or any combination thereof). In some embodiments, the basic compound comprises ammonia.

Embodiment 19C is the porous substrate of embodiment 17C, wherein the adsorbent is capable of adsorbing an acidic compound. The acidic compound may be in a liquid state, gaseous and/or vapor state (preferably), or both. In some embodiments, the acidic compound comprises sulfur dioxide, nitrogen dioxide, hydrogen sulfide, sulfur trioxide, nitric oxide, or any combination thereof.

Embodiment 20C is the porous substrate of embodiment 17C, wherein the adsorbent is capable of adsorbing an inorganic compound. The inorganic compound may be in a liquid state, gaseous and/or vapor state (preferably), or both. In some such embodiments, the adsorbent includes activated carbon, a zeolite (e.g., zeolite X, zeolite A, zeolite Y, zeolite β, and zeolite ZsM-5), a silicate, a metal-organic framework (MOFs), a mesoporous transition metal oxide, or any combination thereof. In some embodiments the inorganic compound includes carbon dioxide; carbon monoxide; water; a perfluorocarbon (e.g., tetrafluoromethane and hexafluoroethane); sulfur hexafluoride; hydrogen sulfide; a nitrogen oxide; a sulfur oxide; ozone; or any combination thereof.

Embodiment 21C is the porous substrate of embodiment 17C, wherein the adsorbent is capable of adsorbing an organic compound. The organic compound may be in a liquid state, gaseous and/or vapor state (preferably), or both. The organic compound may comprises an aromatic hydrocarbon (e.g., toluene, benzene, xylene, and ethylbenzene); a siloxane; a polycyclic aromatic hydrocarbon (e.g., naphthalene, acenaphthylene, acenaphthene, fluorene, phenanthrene, anthracene, fluoranthene, pyrene, benz(a)anthracene, chrysene, benzo(b)fluoranthene, benzo(k)fluoranthene, benzo(a)fluoranthene, dibenz(a,h)anthracene, benzo(ghi)perylene, and indeno(1,2,3-cd)pyrene)); an n-alkane (e.g., methane, ethane, propane, butane, pentane, and hexane); an n-alkene (e.g., methylene, ethylene, and propylene); an aldehyde (e.g., formaldehyde); an alcohol; a siloxane; or any combination thereof. In some such embodiments, the catalysts includes activated carbon, a zeolite (e.g., zeolite X, zeolite A, zeolite Y, zeolite β, and zeolite ZSM-5), a silicate, a metal-organic frameworks (MOFs), a mesoporous transition metal oxide, or any combination thereof

Embodiment 22C is the porous substrate of any one of embodiments 16C through 21C, wherein the adsorbent is a chemisorbent, a physisorbent or a physisorbent-chemisorbent hybrid; and wherein the physisorbent comprises activated carbon, a zeolite, a silicate, a metal-organic framework (MOFs), a mesoporous transition metal oxide, or combinations thereof.

Embodiment 23C is the porous substrate embodiment 19C wherein the adsorbent comprises a chemisorbent or a physisorbent-chemisorbent hybrid, and wherein the chemisorbent comprises a group I metal carbonate; a metal oxide; a group I metal hydroxide; a group II metal hydroxide; an N-containing compound such as an amine, an imine, an ammonium salt, and combinations thereof; or combinations thereof. In some embodiments, the N-containing compound comprises polyethyleneimine, tetraethylenepentamine, ethylenediamine, 3-aminopropyltriethoxysilane, ammonium persulfate, or combinations thereof.

Embodiment 24C is the porous substrate of embodiment 12C, wherein the plurality of active particles, the free active particles (if present), or both, comprise a growth seed; and wherein the growth seed is a nucleation point for the growth of a metal-organic framework (MOF). In some embodiments, the growth seed comprises copper nitrate, trimesic acid, or both.

Embodiment 25C is the porous substrate of embodiment 12C, wherein the plurality of active particles, the free active particles (if present), or both, comprise an MOF; and wherein the MOF comprises copper benzene-1,3,5-tricarboxylate.

Embodiment 26C is the porous substrate of embodiment 12C, wherein the plurality of active particles comprises an electroactive material; and wherein the electroactive material is an anode electroactive material, a cathode electroactive material, or both.

Embodiment 27C is the composition of embodiment 12C or 26C, wherein the electroactive material comprises lithium or lithium and one or more metals.

Embodiment 28C is the porous substrate of embodiment 12C, wherein the plurality of active particles comprises a bioactive material. The bioactive material may be a protein, a lipid, a nucleotide, a nucleic acid, a saccharide, a polysaccharide, or any combination thereof. The protein may be an enzyme. The enzyme may be lactase.

Embodiment 29C is the porous substrate of any one of embodiments 1C through 28C, wherein the plurality of active particles, the free active particles (if present), or both, have an average particle size of 0.001 μm or greater, 0.01 μm or greater, 0.1 μm or greater, 1 μm or greater, 5 μm or greater, 10 μm or greater, or 100 μm or greater as measured according to the Dimensional Analysis Test Method. The plurality of active particles, the free active particles (if present), or both, may have an average particle size of 500 μm or less, 100 μm or less, 10 μm or less, or 1 μm or less as measured according to the Dimensional Analysis Test Method. In some embodiments where the plurality of active particles, the free active particles (if present), comprise a catalyst, the average particles size is 0.001 μm to 5 μm, 0.001 μm to 1 μm, or 0.001 μm to 0.1 μm as measured according to the Dimensional Analysis Test Method. In some embodiments where the plurality of active particles, the free active particles (if present), comprise an adsorbent, the average particles size is 0.001 μm to 100 μm, 1 μm to 100 μm, or 0.001 μm to 0.1 μm as measured according to the Dimensional Analysis Test Method.

Embodiment 30C is the porous substrate of any one of embodiments 1C through 29C, wherein the short-strand PTFE fibrils may have an average length of 30 μm or less, 20 μm or less, 10 μm or less, or 5 μm or less as measured according to the Dimensional Analysis Test Method. The short-strand PTFE fibrils may have an average length of 1 μm or greater, 5 μm or greater, 10 μm or greater, or 20 μm or greater as measured according to the Dimensional Analysis Test Method.

Embodiment 31C is the porous substrate of any one of embodiments 1C through 29C, wherein the long-strand PTFE fibrils may have an average length of 40 μm or greater, 100 μm or greater, 150 μm or greater, 250 μm or greater, 500 μm or greater, or 1000 μm or greater, as measured according to the Dimensional Analysis Test Method. The long-strand PTFE fibrils have may an average length of 2000 μm or less, 1000 μm or less, 700 μm or less, 500 μm or less, 250 μm or less, 150 μm or less, or 100 μm or less as measured according to the Dimensional Analysis Test Method.

Embodiment 32C is the porous substrate of any one of embodiments 1C through 31C, wherein the short-strand PTFE fibrils may have an average diameter of 0.01 μm or greater, 0.05 μm or greater, 0.3 μm or greater, or 0.5 μm or greater as measured according to the Dimensional Analysis Test Method. The short-strand PTFE fibrils may have an average diameter of 1 μm or less, 0.5 μm or less, or 0.3 μm or less as measured according to the Dimensional Analysis Test Method.

Embodiment 33C is the porous substrate of any one of embodiments 1C through 32C, wherein the long-strand PTFE fibrils may have an average diameter of 100 μm or less, 50 μm or less, 10 μm or less, or 1 μm or less as measured according to the Dimensional Analysis Test Method. The long-strand PTFE fibrils may have an average diameter of 0.5 μm or greater, 1 μm or greater, 10 μm or greater or 50 μm or greater as measured according to the Dimensional Analysis Test Method.

Embodiment 34C is the porous substrate of any one of embodiments 1C through 33C, wherein the substrate having the composition disposed thereon includes 0.001 wt-% or greater, 0.01 wt-% or greater, 0.1 wt-% or greater, 5 wt-% or greater, 10 wt-% or greater, 20 wt-% or greater, 30 wt-% or greater, 40 wt-% or greater, 50 wt-% or greater, 60 wt-% or greater, 70 wt-% or greater, 80 wt-% or greater, 90 wt-% or greater, or 95 wt-% or greater of the porous substrate based on the total weight of the substrate-composition (the total weight of the substrate and the composition disposed thereon) and calculated according to the Composition Analysis Test Method. In some embodiments, the porous substrate having a composition disposed thereon includes 99 wt-% or less, 95 wt-% or less, 90 wt-% or less, 80 wt-% or less, 70 wt-% or less, 60 wt-% or less, 50 wt-% or less, 40 wt-% or less, 30 wt-% or less, 20 wt-% or less, 10 wt-% or less, 5 wt-% or less, 1 wt-% or less, or 0.01 wt-% or less of the porous substrate based on the total weight of the substrate-composition and calculated according to the Composition Analysis Test Method.

Embodiment 35C is the porous substrate of any one of embodiments 1C through 34C, wherein the substrate having the composition disposed thereon includes 0.001 wt-% or greater, 0.01 wt-% or greater, 0.1 wt-% or greater, 5 wt-% or greater, 10 wt-% or greater, 20 wt-% or greater, 30 wt-% or greater, 40 wt-% or greater, 50 wt-% or greater, 60 wt-% or greater, 70 wt-% or greater, 80 wt-% or greater, 90 wt-% or greater, or 95 wt-% or greater of the composition based on the total weight of the substrate-composition and calculated according to the Composition Analysis Test Method. In some embodiments, the composition having a composition disposed thereon includes 99 wt-% or less, 95 wt-% or less, 90 wt-% or less, 80 wt-% or less, 70 wt-% or less, 60 wt-% or less, 50 wt-% or less, 40 wt-% or less, 30 wt-% or less, 20 wt-% or less, 10 wt-% or less, 5 wt-% or less, 1 wt-% or less, or 0.01 wt-% or less of the composition based on the total weight of the substrate-composition and calculated according to the Composition Analysis Test Method.

Embodiment 36C is the porous substrate of any one of embodiments 1C through 35C wherein the composition comprises 0.1 wt-% or greater, 5 wt-% or greater, 15 wt-% or greater, 25 wt-% or greater, 45 wt-% or greater, 55 wt-% or greater, 65 wt-% or greater, or 80 wt-% or greater of the plurality of PTFE fibrils based on the total weight of the composition calculated according to the Composition Analysis Test Method. The composition may comprise 95 wt-% or less, 80 wt-% or less, 65 wt-% or less, 55 wt-% or less, 45 wt-% or less, 25 wt-% or less, 15 wt-% or less, or 5 wt-% or less of the plurality of PTFE fibrils based on the total weight of the composition calculated according to the Composition Analysis Test Method.

Embodiment 37C is the porous substrate of any one of embodiments 1C through 36C, wherein the substrate having the composition disposed thereon includes 1 wt-% or greater, 5 wt-% or greater, 15 wt-% or greater, 25 wt-% or greater, 45 wt-% or greater, 55 wt-% or greater, 65 wt-% or greater, or 80 wt-% or greater of PTFE fibrils (total of short-strand PTFE fibrils and long-strand PTFE fibrils) based on the total weight of the substrate-composition and calculated according to the Composition Analysis Test Method. In some embodiments, the composition comprises 95 wt-% or less, 80 wt-% or less, 65 wt-% or less, 55 wt-% or less, 45 wt-% or less, 25 wt-% or less, 15 wt-% or less, or 5 wt-% or less PTFE fibrils based on the total weight of the substrate-composition and calculated according to the Composition Analysis Test Method.

Embodiment 38C is the porous substrate of any one of embodiments 1C through 37C, wherein the composition comprises 0.1 wt-% or greater, 1 wt-% or greater, 5 wt-% or greater, 15 wt-% or greater, 25 wt-% or greater, 45 wt-% or greater, 55 wt-% or greater, 65 wt-% or greater, or 80 wt-% or greater of the short-strand PTFE fibrils (if present) based on the total weight of the composition calculated according to the Composition Analysis Test Method. The composition comprises 95 wt-% or less, 80 wt-% or less, 65 wt-% or less, 55 wt-% or less, 45 wt-% or less, 25 wt-% or less, 15 wt-% or less, 5 wt-% or less, or 1 wt-% or less of the short-strand PTFE fibrils (if present) based on the total weight of the composition calculated according to the Composition Analysis Test Method.

Embodiment 39C is the porous substrate of any one of embodiments 1C through 38C, wherein the composition comprises 0.01 wt-% or greater, 1 wt-% or greater, 5 wt-% or greater, or 10 wt-% or greater, 15 wt-% or greater, 20 wt-% or greater, 30 wt-% or greater, or 40 wt-% or greater of the long-strand PTFE fibrils (if present) based on the total weight of the composition calculated according to the Composition Analysis Test Method. The composition comprises 50 wt-% or less, 40 wt-% or less, 30 wt-% or less, 20 wt-% or less, 15 wt-% or less, 10 wt-% or less, 5 wt-% or less, or 1 wt-% or less of the long-strand PTFE fibrils (if present) based on the total weight of the composition calculated according to the Composition Analysis Test Method.

Embodiment 40C is the porous substrate of any one of embodiments 1C through 39C, wherein the composition includes 50 wt-% or greater, 70 wt-% or greater, 80 wt-% or greater, or 90 wt-% or greater active particles by weight of the composition and/or matrix, per the Composition Analysis Test Method. In some embodiments, the total active particle wt-% in the composition and/or matrix is 95 wt-% or less, 90 wt-% or less, 80 wt-% or less, or 70 wt-% or less by weight of the composition and/matrix, per the Composition Analysis Test Method. In some embodiments, the total active particle wt-% in a composition and/or matrix is 0 wt-% or greater, 0.001 wt-% or greater, 0.01 wt-% or greater, 0.1 wt-% or greater, 1 wt-% or greater, 2 wt-% or greater, 3 wt-% or greater, 4 wt-% or greater, 5 wt-% or greater, 10 wt-% or greater, or 15 wt-% or greater by weight of the composition and/or matrix, per the Composition Analysis Test Method. In some embodiments, the total active particle wt-% in a composition and/matrix is 20 wt-% of less, 15 wt-% or less, 10 wt-% or less, 5 wt-% or less, 4 wt-% or less, 3 wt-% or less, 2 wt-% or less, 1 wt-% or less, 0.1 wt-% or less, 0.01 wt-% or less, or 0.001 wt-% or less, by weight of the composition and/or matrix, per the Composition Analysis Test Method.

Embodiment 41C is the porous substrate of any one of embodiments 1C through 40C, wherein the substrate having the composition disposed thereon includes 0 wt-% or greater, 1 wt-% or greater, 2 wt-% or greater, 3 wt-% or greater, 4 wt-% or greater, 5 wt-% or greater, 10 wt-% or greater, or 15 wt-% or greater, 20 wt-% or greater, 30 wt-% or greater, 40 wt-% or greater, 50 wt-% or greater, 70 wt-% or greater, 80 wt-% or greater, or 90 wt-% or greater active particles based on the total weight of the substrate-composition and calculated according to the Composition Analysis Test Method. In some embodiments, the porous substrate having a composition disposed thereon includes 95 wt-% or less, 90 wt-% or less, 80 wt-% or less, 70 wt-% or less, 50 wt-% or less, 40 wt-% or less, 30 wt-% or less, 20 wt-% or less, 15 wt-% or less, 10 wt-% or less, 5 wt-% or less, 4 wt-% or less, 3 wt-% or less, 2 wt-% or less, or 1 wt-% or less active particles based on the total weight of the substrate-composition and calculated according to the Composition Analysis Test Method.

### METHOD EMBODIMENTS

Embodiment 1M is a method for disposing a composition on a porous substrate to result in the porous substrate of any one of embodiments 1C through 30C,
the composition comprising a matrix comprising a plurality of PTFE fibrils formed from PTFE resin; and a plurality of active particles;
the method comprising:
i) optionally aerating an emulsion to form an aerated emulsion, the emulsion and the aerated emulsion comprising: the PTFE resin, a surfactant, and a dispersant;
ii) optionally adding a solid particulate composition to the aerated emulsion to form a pre-mixture comprising: the PTFE resin, the surfactant, the dispersant, and the solid particulate composition;
iii) optionally aerating the matrix pre-mixture to form an aerated matrix pre-mixture; the aerated matrix pre-mixture comprising the matrix pre-mixture;
iv) contacting at least a portion of a porous substrate with the matrix pre-mixture or the aerated matrix pre-mixture;
v) allowing a hydrated composition to be disposed on the porous substrate, the hydrated composition comprising: the matrix, at least a portion of the dispersant, and at least a portion of the surfactant, the plurality of active particles comprising at least a portion of the solid particulate; and
vi) drying the hydrated composition to form the composition disposed on the porous substrate.

Embodiment 2M is a method for disposing a composition on a porous substrate to result in the porous substrate of any one of embodiments 1C through 30C,
the composition comprising a matrix comprising a plurality of PTFE fibrils formed from PTFE resin; and a plurality of active particles;
the method comprising:
i) optionally forming a matrix pre-mixture, the matrix pre-mixture comprising PTFE resin, a surfactant, and a dispersant;
ii) optionally aerating the matrix pre-mixture to form an aerated matrix pre-mixture, the aerated matrix pre-mixture comprising the matrix pre-mixture;
iii) contacting at least a portion of a porous substrate with a matrix pre-mixture or an aerated matrix pre-mixture;
iv) contacting the at least a portion of the substrate with a solid particulate composition, the solid particulate composition comprising a solid particulate;
v) allowing a hydrated composition to be disposed on the at least a portion of the porous substrate; the hydrated composition comprising: the matrix, at least a portion of the dispersant, and at least a portion of the surfactant, the plurality of active particles comprising at least a portion of the solid particulate; and
vi) drying the hydrated composition to form the composition disposed on the porous substrate.

Embodiment 3M is the method of embodiment 1M of 2M, wherein the composition further comprises free active particles, free PTFE particles, or both.

Embodiment 4Ma is the method of any one of embodiments M1 through 3M, wherein the porous substrate comprises a major surface and a plurality of macro/micro pores coupled to the major surface; wherein a first portion of the composition is disposed on at least a portion of the major surface, and wherein at least a portion of the macro/micro pores are impregnated with a second portion of the composition.

Embodiment 4Mb is the method of embodiment 4Ma, wherein the composition further comprises free active particles; wherein the at least a portion of the macro/micro pores comprises a first portion of macro/micro pores; and wherein the first portion of macro/micro pores is impregnated with a first component of the composition and a second portion of macro/micro pores are impregnated with a second component of the composition. In some embodiments, the first component and the second component are the matrix and at least one particle of the free active particles.

Embodiment 5M is the method of any one of embodiments M1 through 4M(a and b), wherein the porous substrate is a wettable porous substrate comprising a plurality of collapsible pores, and a third portion of the composition is embedded within the porous substrate.

Embodiment 6M is the method of embodiment 5M (as dependent on embodiment 3M), wherein one or more components of the composition are embedded within the porous substrate. In some embodiments, at least one particle of the free active particles are embedded within the porous substrate, at least one PTFE fibril of the free PTFE fibrils are embedded within the substrate, a portion of the matrix is embedded within the substrate, or any combination thereof.

Embodiment 7M is the method of any one of embodiments 1M through 6M, wherein the plurality of PTFE fibrils of the matrix, free PTFE fibrils, or both comprise short-strand PTFE fibrils, long-strand PTFE fibrils, or both.

Embodiment 8M is the method of embodiment 7M (as dependent on 3M), wherein the free PTFE fibrils comprise, long-strand PTFE fibrils, short-strand PTFE fibrils, or both.

Embodiment 9M is the method of embodiment 7M (as dependent on embodiment 1M), wherein the PTFE resin of the aerated matrix pre-mixture comprise short-strand PTFE resin and long-strand PTFE resin.

Embodiment 10M is the method of embodiment 9M, wherein the PTFE resin of the emulsion, the PTFE resin of the aerated emulsion, the PTFE resin of the concentrated matrix pre-mixture, and the PTFE resin of the matrix pre-mixture comprise short-strand PTFE resin.

Embodiment 11M is the method of embodiment 10M, wherein the method further comprises adding long-strand PTFE resin to the emulsion such that the PTFE resin of the emulsion, the PTFE resin of the aerated emulsion, and the PTFE resin of the matrix pre-mixture further comprise long-strand PTFE resin.

Embodiment 12M is the method of embodiment 10M, wherein the method further comprises adding long-strand PTFE resin to the matrix pre-mixture such that the PTFE resin of the matrix pre-mixture further comprise long-strand PTFE resin.

Embodiment 13M is the method of embodiment 7M (as dependent on embodiment 2M), wherein the PTFE resin of the matrix pre-mixture or the aerated matrix pre-mixture comprise short-strand PTFE resin and long-strand PTFE resin.

Embodiment 14M is the method of embodiment 13M, wherein the plurality of PTFE resin of the matrix pre-mixture, the plurality of PTFE resin of the aerated matrix pre-mixture, or both, comprise short-strand PTFE resin.

Embodiment 15M is the method of embodiment 14M, wherein the method further comprises adding long-strand PTFE resin to the matrix pre-mixture or the aerated matrix premixture such that the PTFE resin of the matrix premixture and/or the aerated matrix pre-mixture further comprise short-strand PTFE.

Embodiment 16M is the method of any one of embodiments 1M through 15M, wherein the aerated matrix pre-mixture and/or the matrix pre-mixture comprise 0.01 wt-% or greater, 15 wt-% or greater, 25 wt-% or greater, 45 wt-%, or greater 55 wt-% or greater, or 65 wt-% or greater of the PTFE resin based on the total weight of the aerated matrix pre-mixture or the matrix pre-mixture. The aerated matrix pre-mixture and/or the matrix pre-mixture comprise 80 wt-% or less, 65 wt-% or less, 55 wt-% or less, 45 wt-% or less, 25 wt-% or less, or 15 wt-% or less of the PTFE resin based on the total weight of the aerated matrix pre-mixture or the matrix pre-mixture.

Embodiment 17M is the method of any one of embodiments 1M through 16M, wherein the aerated matrix pre-mixture and/or the matrix pre-mixture comprises 0.01 wt-% or greater, 1 wt-% or greater, 5 wt-% or greater, or 10 wt-% or greater of the long-strand PTFE resin based on the total weight of the aerated matrix pre-mixture or the matrix pre-mixture. The aerated matrix pre-mixture and/or the matrix pre-mixture comprises 15 wt-% or less, 10 wt-% or less, 5 wt-% or less, or 1 wt-% or less of the long-strand PTFE resin based on the total weight of the aerated matrix pre-mixture or the matrix pre-mixture.

Embodiment 18M is the method of any one of embodiments 1M through 17M, wherein the aerated matrix pre-mixture and/or the matrix pre-mixture comprises 0.1 wt-% or greater, 5 wt-% or greater, 15 wt-% or greater, 25 wt-% or greater, 45 wt-% or greater, or 55 wt-% or greater of the short-strand PTFE based on the total weight of the aerated matrix pre-mixture or the matrix pre-mixture. The aerated matrix pre-matrix and/or the matrix pre-mixture comprises 80 wt-% or less, 55 wt-% or less, 45 wt-% or less, 25 wt-% or less, 15 wt-% or less, or 5 wt-% or less of the short-strand PTFE resin based on the total weight of the aerated matrix pre-mixture or the matrix pre-mixture.

Embodiment 19M is the method of any one of embodiments 1M through 18M, wherein the solid particulate composition comprises 100 wt-% of the solid particulate.

Embodiment 20M is the method of any one of embodiments 1M through 19M, wherein the solid particulate composition further comprises a liquid carrier. In some embodiments where the porous substrate is a wettable porous substrate, the liquid carrier comprises a wetting liquid. In some embodiments, the liquid carrier comprises water, one or more organic solvents (e.g., ethyl acetate, ethanol, methanol, isopropanol, butanol, dichloromethane, toluene, acetonitrile, acetone, diethyl ether, amyl alcohol, and tetrahydrofuran) or both.

Embodiment 21M is the method of embodiment 20M, wherein the solid particulate composition comprises 0.5 wt-% or greater, 10 wt-% or greater, 30 wt-% or greater, or 50 wt-% or greater of the solid particulate based on the total weight of the solid particulate composition. The solid particulate composition comprises 90 wt-% or less, 50 wt-% or less, 30 wt-% or less, or 10 wt-% or less of the solid particulate based on the total weight of the solid particulate composition.

Embodiment 22M is the method of any one of embodiments 2M through 7M (as dependent on 2M) or 13M through 21M (as dependent on 2M), wherein the solid particulate composition comprises a first solid particulate, and the matrix pre-mixture or aerated matrix pre-mixture further comprises a second solid particulate. In such embodiments, the plurality of active particles, the free active particles (if present), or both, comprise at least a portion of the second solid particulate.

Embodiment 23M is the method of embodiment 22M, wherein the matrix pre-mixture or the aerated matrix pre-mixture include 0.5 wt-% or greater, 10 wt-% or greater, or 30 wt-% or greater of the second solid particulate based on the total weight of the matrix pre-mixture or the aerated matrix pre-mixture. The matrix pre-mixture or the aerated matrix pre-mixture comprise 50 wt-% or less, 30 wt-% or less, or 10 wt-% or less of the second solid particulate based on the total weight of the matrix pre-mixture or the aerated matrix pre-mixture.

Embodiment 24M is the method of any one of embodiments 2M through 7M (as dependent on 2M) or 13M through 23M (as dependent on 2M), wherein the solid particulate composition comprises a first solid particulate composition; and wherein the method further comprises contacting the at least a portion of the substrate with a second solid particulate composition. In some embodiments, the first solid particulate composition and the second solid particulate composition may be the same. In other embodiments, the first solid particulate composition and the second solid particulate composition may be different (e.g., different solid particulate, different liquid carrier if present, different wt-% of the solid particulate, or any combination thereof).

Embodiment 25M is the method of any one of embodiments 1M through 12M (as dependent on embodiment 1M) or 16M through 21 (as dependent on embodiment 1M), wherein allowing a hydrated composition to be disposed on the porous substrate further comprises mixing the matrix pre-mixture of the aerated matrix pre-mixture while in contact with the at least a portion of the substrate such a hydrated composition is disposed on the at least a portion of the substrate.

Embodiment 26M is the method of anyone of embodiments 1M through 25M, wherein the method further comprises contacting the at least a portion of the porous substrate with a wetting liquid that does not include a solid particulate. In some embodiments, the wetting liquid comprises one or more organic solvents (e.g., ethyl acetate, ethanol, methanol, isopropanol, butanol, dichloromethane, toluene, acetonitrile, acetone, diethyl ether, amyl alcohol, and tetrahydrofuran).

Embodiment 27M is the method of embodiment 26M (as dependent on embodiment 2M), wherein the at least a portion of the porous substrate is contacted with wetting liquid after contacting the at least a portion of the substrate with the matrix pre-mixture or aerated matrix pre-mixture and after contacting the at least a portion of the substrate with the solid particulate composition.

Embodiment 28M is the method of any one of embodiments 1M through 27M, wherein drying the hydrated composition further comprises removing at least a portion of the dispersant, the liquid carrier (if present), the surfactant, or combinations thereof, by contacting at least a portion of the hydrated composition with an absorbent material.

Embodiment 29M is the method of embodiment 28M, wherein the hydrated composition is in contact with the absorbent material for 10 seconds or more, 1 minute or greater, or 1 hour or greater. The hydrated composition is in contact with the absorbent material for 24 hours or less, 1 hour or less, or 1 minute or less.

Embodiment 30M is the method of embodiment 28M or 29M, further comprising removing at least a portion of the absorbent material from contacting the hydrated composition; and repeating the steps of contacting the hydrated composition with the absorbent material and removing at least a portion of the absorbent material from contacting the hydrated composition, a number of times, each time using an absorbent material that had not been previously contacted with the hydrated composition.

Embodiment 31M is the method of any one of embodiments 28M through 30M, wherein the absorbent material comprises cotton; cellulose; a sponge comprising: polyester, polyurethane, vegetal cellulose, melamine, or combinations thereof; anhydrous calcium chloride; anhydrous magnesium sulfate; sodium polyacrylate; or combinations thereof.

Embodiment 32M is the method of any one of embodiments 1M through 31M, wherein drying the hydrated composition further comprises exposing the hydrated composition to an elevated temperature, applying a vacuum to the hydrated composition, or both.

Embodiment 33M is the method of embodiment 32M, wherein drying the hydrated composition further comprises exposing the hydrated composition to a temperature of 100° C. to 400° C., preferably 100° C. to 300° C., for 0.1 hour to 24 hours, preferably 1 hour to 5 hours.

Embodiment 34M is the method of any one of embodiments 1M through 33M, wherein the aerated matrix pre-mixture and/or the matrix pre-mixture comprises 0.5 wt-% or greater, 5 wt-% or greater, or 20 wt-% or greater of the surfactant based on the total weight of the aerated matrix pre-mixture or the matrix pre-mixture. The aerated matrix pre-mixture and/or the matrix pre-mixture comprises 40 wt-% or less, 20 wt-% or less, or 5 wt-% or less of the surfactant based on the total weight of the aerated matrix pre-mixture or the matrix pre-mixture.

Embodiment 35M is the method of any one of embodiments 1M through 34M, wherein the surfactant comprises a nonionic nonfluorinated surfactant.

Embodiment 36M is the method of embodiment 35M, wherein the surfactant comprises polyethylene glycol trimethylnonyl ether.

Embodiment 37M is the method of any one of embodiments 1M through 36M, wherein the method results in a total active particle loading capacity that is 50 wt-% or greater, 70 wt-% or greater, 80 wt-% or greater, or 90 wt-% or greater based on the Composition Analysis Test Method (i.e., Loading Capacity Test Method). The methods of the present disclosure results in a total active particle loading capacity that is 95 wt-% or less, 90 wt-% or less, 80 wt-% or less, or 70 wt-% or less based on the Composition Analysis Test Method (i.e., Loading Capacity Test Method).

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, MO; Carus, Peru, IL; Calgon Carbon, Moon Township, PA; Ultramet, Los Angeles, CA; or may be synthesized by conventional methods.

The following abbreviations may be used in the following examples and/or other places in this disclosure: Mn=number average molecular weight; ppm=parts per million; ppb=parts per billion; mL=milliliter; L=liter; LPM=liters per minute; m=meter, mm=millimeter, min=minutes; s=seconds; cm=centimeter, μm=micrometer, kg=kilogram, g=gram, min=minute, s=second, h=hour, ° C.=degrees Celsius, ° F.=degrees Fahrenheit; wt-%=weight percent; M=molar; μM=micromole; mM=millimolar; and DI water=deionized water.

Table 1 is a materials table giving a list of components used in the Examples and their associated vendor source, abbreviation, and chemical abstract service (CAS) number.

TABLE 1
Materials and associated information.

| Material | Vendor | Abbreviation | CAS# |
|---|---|---|---|
| K₂CO₃ (99%) | Sigma-Aldrich | — | 584-08-7 |
| Emulsified | Sigma-Aldrich | PTFE-E | 9002-84-0 |
| Polytetrafluoroethylene | | Surfactant | |
| in water and | | abbreviated as | |
| polyethylene glycol | | PEG-TMNE | |
| trimethylnonyl ether | | | |
| (60% PTFE) | | | |
| Polytetrafluoroethylene | Sigma-Aldrich | PTFE-12 | 9002-84-0 |
| powder (<12 μm) | | | |
| Coconut Shell | Calgon | CSAC | EN186 |
| Activated Carbon | | | |
| Reticulated | — | PU-15 | — |
| Polyurethane (15 pores | | | |
| per inch) | | | |
| Reticulated Vitreous | Ultramet | RVC-15 | — |
| Carbon Foam (15 pores | | | |
| per inch) | | | |
| Ethanol (ACS Grade) | Sigma-Aldrich | EtOH | 64-17-5 |
| Distilled Water | In-house | DI | — |

### Test Methods

### Dimensional Analysis

Dimensional analysis and the topography analysis of the various compositions and substrates of the examples were accomplished via scanning electron microscopy (SEM) on a JSM-7100F microscope. Prior to imaging the samples, samples were sputter coated for 120 seconds with gold/palladium to prevent charging. Measurements to calculate the average length of long-strand PTFE fibrils, the average resin particle size of long-strand PTFE resin; the average length of short-strand PTFE fibrils; the average resin particle size of short-strand PTFE resin; the average diameter of short-strand PTFE fibrils, the average diameter of long-strand PTFE fibrils; the average particle size of the plurality of active particles; the average particle size of the free active particles; and the average porosity were then taken using ImageJ software. Ten replicate measurements of the lengths/widths/diameters/particle sizes were taken to generate the average for various elements.

### Acidic Gas Breakthrough

The coated polyurethane foam was subjected to H₂S adsorption as a proof-of-concept. The foam was laminated with a 25% surface opening on the inlet side (left-hand entrance) and a 25% opening on the outlet side (right-hand exit) to generate an S-shaped flow profile and maximize the fluid residence time. The H₂S breakthrough performance was assessed at 25 ppm with an initial flowrate of 100 cm³/min followed by 300 cm³/min after 1200 min. The sample was allowed to saturate until 32% (8 ppm) of the initial H₂S concentration was achieved, which required an approximate time of 6000 minutes.

### Composition Analysis

The amount of each component in a matrix/composition and composition-substrate complex is calculated according to the following Composition Analysis Test Method. The Composition Analysis Test Method may be referred to as the Loading Capacity Test Method.

The solid loading capacity of composition materials was calculated from the initial wetted formulations by assuming homogeneous mixing of the solids and full removal of the water/surfactant mixture. As one example, a matrix and/or composition was formed from 13.3 g CARULITE, 5 g PTFE-E, and 3 g of PTFE-12 (a total weight of 21.3 g). Knowing that the PTFE-E material was comprised of 60 wt-% PTFE solids as detailed by the manufacturer, the weight of PTFE solids derived thereof was calculated as the product of the weight fraction of PTFE solids and the weight used (e.g., if 5 g of PTFE-E was used, then 60%_{PTFE-Solids}×5 gₑₘᵤₗₛᵢₒₙ=3 g_{PTFE solids}). The solid content for each component was then calculated on a dry component basis; that is, the calculation did not consider any contribution of the water or surfactant components using the following equation:

$$\\ {X}_{i} = \frac{{M}_{i}}{{M}_{1} + {M}_{2} … ++ {M}_{n}} \cdot 100 \%$$

where Xᵢ is the weight percentage of a singular component after drying and Mᵢ is individual mass of the solid component (g) used in the matrix formulation without any solvent. For example, if a composition including 10 g CARULITE, 5 g PTFE-E, and 3 g PTFE-12 were formulated, then the solid fraction of CARULITE could be defined as:

$$\\ {X}_{CARULITE} = \frac{10 g ( carulite )}{10 g ( carulite ) + 3 g ( PTFE - 12 ) + 60 \% {}_{} * 5 g ( PTFE - E )} \cdot 100 \% .$$

Therefore, the composition or matrix included a total wt-% of active particles (CARULITE) or 62.5 wt-%. The composition or matrix also included 18.6 wt-% short-strand PTFE fibrils and 18.6 wt-% long-strand PTFE fibrils. Stated differently, the composition or matrix included 62.5 wt-% active particles and 37.2 wt-% PTFE fibrils.

For a substrate having a composition disposed thereon, the mass of the substrate and the mass of the matrix/composition disposed on the substrate may also be considered. For example, if 0.5 g of the above composition was disposed on a 0.5 g substrate (the difference between the substrate mass before and after disposing the composition was 0.5 g) the amount of each composition component in the substrate-composition would be 50% of the amount in the composition itself. For example, the substrate-composition would be 50 wt-% substrate; 31.25 wt-% active particles; 9.3 wt-% short-strand PTFE fibrils; and 9.3 wt-% long-strand PTFE fibrils.

### Example 1: Disposing a Composition on a Porous Substrate Using a First Method

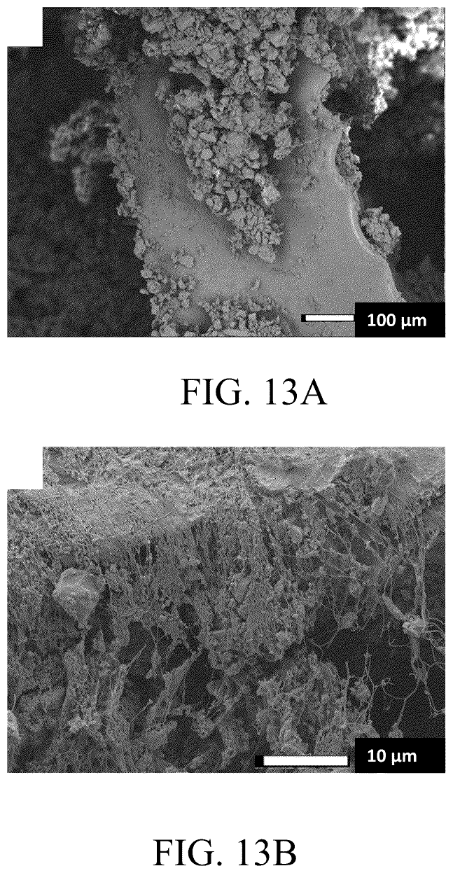

A composition was disposed on PU-15 foam, a porous substrate, using a first method. The composition included PTFE-E, PTFE-12, CSAC, and K₂CO₃. The method included forming an aerated emulsion including 5 g PTFE-E resin and 3 g PTFE-12 resin in 20 ml DI water. Aeration was accomplished via vigorous shaking by hand to induce frothing which suspended the PTFE-12 resin. Next, 13.3 g of CSAC and a solution of 20 g of K₂CO₃ dissolved in 20 mL DI (a solid particulate composition) were added to the aerated emulsion to create a matrix pre-mixture. The water/K₂CO₃ solution was added after addition of the CSAC to prevent destabilization of the PTFE surfactant. A 3 inch (7.62 cm) by 3 inch (7.62 cm) PU-15 foam was then submerged into the matrix pre-mixture, whereafter the liquid was absorbed onto the polymer structure. The sample was then removed from the matrix pre-mixture and dried under vacuum for 24 h to force precipitation of the K₂CO₃. Before disposing of the composition, the foam weighed 1.8051 g. After disposing the composition, the foam weighed 16.2170 g. A nearly tenfold loading was achieved by this method. The foam was then characterized by SEM as shown in FIGS. 13A and 13B and FIGS. 14A and 14B. The SEM image revealed that the composition included a matrix and free active particles. The matrix was allocated primarily to the PU-15 surface (FIG. 13A) as was evident from the particles being fibrillated and interconnected around the polymer layer (FIG. 13B).

However, imaging the PU-15 cross-section (FIGS. 14A and 14B) revealed that some fraction of active particles (i.e., free active particles) were absorbed into the polymeric structural backbone. Specifically, FIG. 14B indicated that small particles were present in-parallel with the PU-15 polymer grains, which was a sign of precipitate growth inside of the polymer wall (embedment of free active particles within the solid portion of the porous polymer substrate). This phenomenon may be attributed to PU-15 being a wettable substrate. As wetting liquid (in this case the water/surfactant mixture) swelled the substrate creating micro pores, an indeterminate amount of dissolved K₂CO₃ may have migrated with the wetting liquid into the micro pores of the structure.

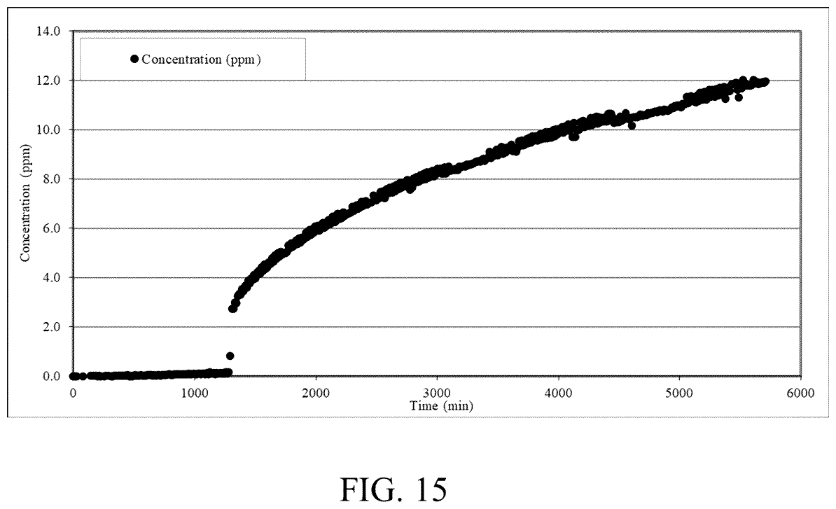

The PU-15 substrate having the composition disposed thereon was assessed for H₂S adsorption to demonstrate the adsorption capabilities of the material as a proof-of-concept. The Acidic Gas Breakthrough Test Method was used. Briefly, the substrate was cut into a 1 inch (2.54 cm) by 1 inch (2.54 cm) configuration and packaged in a manner which generated a z-shaped flow path throughout the structure in efforts of maximizing residence time. More specifically, the PU-15 substrate was laminated in plastic so that 0.25 inches (0.635 cm) of the bottom left and 0.25(0.635 cm) inches of the top right of the packaging were left open, thus generating the z-shaped profile. The H₂S breakthrough performance was assessed at 25 ppm with an initial flowrate of 100 cm³/min followed by 300 cm3/min after 1200 min, as shown in FIG. 15. The substrate was found to adsorb an approximate capacity of 20 mg/g of H₂S which was comparable to the expected value relative to the loaded K₂CO₃ amount. The material pressure drop was also sufficiently small so as to be undetected by the test system, but this may be a byproduct of the small sample size.

### Example 2: Disposing a Composition on a Porous Substrate Using a Second Method

A composition was disposed on a PU-15 porous substrate using a second method. The composition included PTFE-E, PTFE-12, CSAC, and K₂CO₃.

Solid particulate compositions were prepared as follows. CSAC was first impregnated with varying amounts of K₂CO₃ (1:1, 2.5:1 5:1, 10:1 K₂CO₃:CSAC) in 30 mL of DI water. 5 g of impregnated CSAC was added to 30 mL of ethanol to create solid particulate compositions. Ethanol was chosen as the liquid carrier of the solid particulate composition because K₂CO₃ cannot redissolve in alcohols.

A concentrated emulsion (e.g., concentrated matrix pre-mixture) including PTFE-E (25 g)/PTFE-12 (7 g) in water was prepared. The concentrated emulsion was diluted with 20 mL DI to form the matrix pre-mixture. No aeration was done.

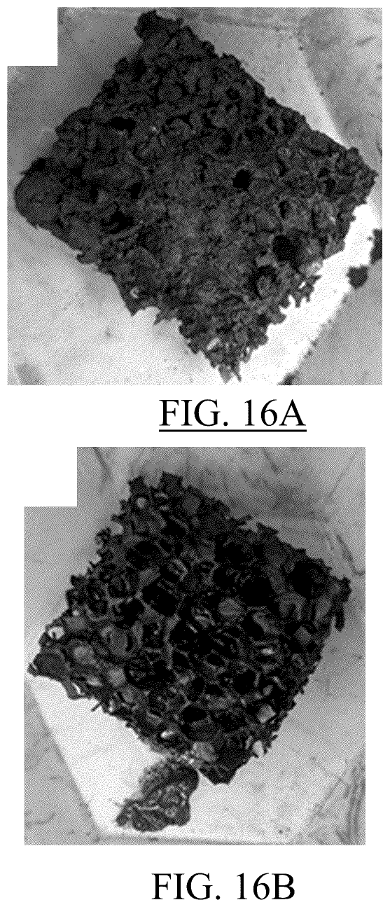

The PU-15 pieces (1 in by 1 in; 2.54 cm by 2.54 cm) dipped into the matrix pre-mixture for 30 seconds on each side, followed by dip submergence in the solid particulate composition bath, followed by dip submergence in an ethanol bath. The pieces were then dried under vacuum at ambient temperature overnight to extract out any remaining water, ethanol, and surfactant and force precipitation of any K₂CO₃ dissolved from residual water in the matrix pre-mixture. As shown in FIGS. 16A and 16B it was observed that coating the PU-15 via this second method (FIG. 16B) resulted in lesser blockage of the PU-15 pores than the method described in Example 1 (FIG. 16A).

### Example 3: Disposing a Composition on a Porous Substrate Using a Third Method and Fourth Method

Example 3 compares a third and fourth method for disposing a composition on a PU-15 substrate. The third and fourth methods both include exposing the substrate to a solid particulate composition that included K₂CO₃ dissolved in water. The fourth method further included exposing the substrate to an ethanol bath (a wetting composition). Additionally, this example compares the characteristics of a porous substrate that have a composition disposed thereon that includes both PTFE-E and PTFE-12 and a porous substrate that has a composition disposed thereon that includes only PTFE-E.

Table 2 shows the components of each composition disposed on each substrate as well as if that substrate was exposed to an ethanol bath (method 4) or no ethanol bath (method 3).

TABLE 2

| Substrate | | | | K₂CO₃ in | Exposure to a 200 |
|---|---|---|---|---|---|
| Number | PTFE-E | PTFE-12 | CSAC | 120 g DI | ml ethanol bath? |
| 1 | 25 g | 0 g | 5 g | 10 g | yes |
| 2 | 25 g | 7 g | 5 g | 10 g | no |
| 3 | 25 g | 7 g | 5 g | 10 g | yes |

Both method 3 and method 4 included aerating a PTFE-E emulsion and diluted with 60 g of DI water to from an aerated emulsion. PTFE-12 (for substrate 2 and 3) was added to the aerated emulsion and mixed until the PTFE-12 resin were no longer visible. Activated carbon was added into the aerated emulsions, followed by mixing via agitation for 2 minutes to from a matrix pre-mixture. The polyurethane foam substrates were submerged into their respective matrix pre-mixtures for 60 seconds. The substrates were then transferred to the bath containing dissolved K₂CO₃ in water (e.g., a solid particulate composition). This step initiated a phase change and yielded macroscopic congealing of the PTFE/carbon/base. After soaking the sample in the K₂CO₃ solution for 60 seconds, substrates 1 and 3 were transferred to a bath containing 200 mL of ethanol, whereupon the congealed carbon/PTFE layer was soaked into the structural backbone of the polyurethane sample.

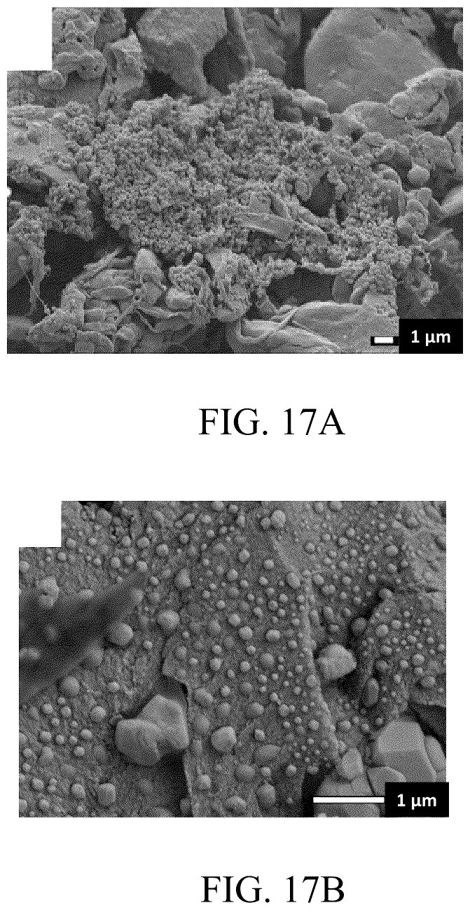

All substrate samples were dried under vacuum (P=0 bar) at 130° C. for 24 h to remove ethanol, water, and surfactant. Electron microscopy was used to compare substrate 1 and substrate 2. FIG. 17A—which assessed the topography of substrate 2—indicated that the coating was primarily allocated to the surface without any clear or obvious nucleation (e.g., embedment) of the K₂CO₃ being present in the polyurethane backbone. In contrast, microscopy of substrate 1 (FIG. 17B) demonstrated that submerging the substrate in ethanol after the K₂CO₃/DI bath transports the K₂CO₃ ions into the polyurethane backbone. Thereafter, the vacuum drying step causes said ions to become supersaturated, eventually precipitating out into the polyurethane in the form of nucleated (e.g., embedded) K₂CO₃ particles (e.g., free active particles). It should be noted here that the use of ethanol as the wetting agent is important in that i) polyurethane is wettable by alcohol and ii) K₂CO₃ is insoluble in ethanol, hence its transport from the initial coating layer into the ethanol bath is less favored relative to transport of the solid phase into the polyurethane. Without being bound by theory, it is thought that residual water in the surface coating acts as a carrier phase to migrate the K₂CO₃ from the surface into the polyurethane, with the ethanol bath acting as a means through which the polyurethane chains open and become wettable to the mixture (e.g., the creation of micropores).

Regarding the role of PTFE-E and PTFE-12, the topographies of substrate 1 and substrate 3 were assessed by electron microscopy, as shown in FIGS. 18A, 18B, 18C, and 18D. FIGS. 18A and 18B of substrate 1 showed macroscopic cracking, which may be caused by swelling from ethanol wetting. Additionally, it was observed that substrate 3 was not mechanically stable, as applying any pressure rendered the reticulated polymer into a powder. By comparison, FIGS. 18C and 18D indicated that including PTFE-12 in substrate 3 produced a surface devoid of macroscopic cracking. Without being bound by theory, it is believed based on FIG. 18D that the PTFE-12 strands filled the macroscopic cracks caused by the ethanol wetting, suggesting that the long-strand PTFE fibrils allow self-healing of the polyurethane backbone. In comparison, the PTFE introduced by PTFE-E may allow for adhesion of the particles, as shown in other examples.

What is claimed is:

1. A porous substrate comprising: a composition disposed thereon;
the composition comprising a matrix, the matrix comprising:
a plurality of PTFE fibrils; and
a plurality of active particles.

2. The porous substrate of claim 1, wherein the plurality of PTFE fibrils comprise short-strand PTFE fibrils and long-strand PTFE fibrils.

3. The porous substrate of claim 1, wherein the porous substrate comprises a major surface and a plurality of macro pores coupled to the major surface; wherein a first portion of the composition is disposed on at least a portion of the major surface; and wherein at least a portion of the plurality of macro pores are impregnated with a second portion of the composition.

4. The porous substrate of claim 3, wherein the porous substrate further comprises a third portion of the composition embedded within the porous substrate.

5. The porous substrate of claim 1, wherein the composition further comprises free active particles, free PTFE fibrils, or both.

6. The porous substrate of claim 5, wherein the porous substrate comprises at least one free PTFE fibril of the free PTFE fibrils, at least one free active particle of the free active particles, at least a portion of the matrix, or any combination thereof embedded within the porous substrate.

7. The porous substrate of claim 1, wherein the plurality of particles comprise a catalyst, an adsorbent, a growth seed, a metal-organic framework (MOF), a bioactive material, an electroactive material, or any combinations thereof.

8. The porous substrate of claim 1, wherein the porous substrate is made from a material comprising reticulated polyurethane without heat treatment; reticulated silicon carbide, reticulated metal, reticulated alumina, reticulated cellulose; reticulated melamine; reticulated activated carbon; or any combination thereof.

9. The porous substrate of claim 1, wherein the composition comprises 1 wt-% or greater of the plurality of active particles based on the weight of the composition according to the Composition Analysis Test Method.

10. The porous substrate of claim 1, wherein the composition comprises 60 wt-% or greater of the plurality of active particles based on the weight of the composition according to the Composition Analysis Test Method.

11. The porous substrate of claim 1, wherein the porous substrate comprises 0.001 wt-% to 95 wt-% of the composition based on the weight of the porous substrate and the composition disposed thereon according to the Composition Test Method.

12. The porous substrate of claim 1, wherein the porous substrate comprises 50 wt-% or greater of the composition based on the weight of the porous substrate and the composition disposed thereon according to the Composition Test Method.

13. A method for disposing a composition on a porous substrate,
the composition comprising a matrix comprising a plurality of PTFE fibrils formed from PTFE resin; and a plurality of active particles;
the method comprising:
i) optionally aerating an emulsion to form an aerated emulsion, the emulsion and the aerated emulsion comprising:
PTFE resin;
a surfactant; and
a dispersant;
ii) optionally adding a solid particulate composition to the aerated emulsion to form a matrix pre-mixture, the solid particulate composition comprising a solid particulate, the matrix pre-mixture comprising:
the PTFE resin:
the surfactant;
the dispersant; and
the solid particulate composition;
iii) optionally aerating the matrix pre-mixture to form an aerated matrix pre-mixture; the aerated matrix pre-mixture comprising the matrix pre-mixture;
iv) contacting at least a portion of a porous substrate with the matrix pre-mixture or the aerated matrix pre-mixture;
v) allowing a hydrated composition to be disposed on the substrate, the hydrated composition comprising:
the matrix;
at least a portion of the dispersant; and
at least a portion of the surfactant;
the plurality of active particles comprising at least a portion of the solid particulate; and
vi) drying the hydrated composition to form the composition disposed on the porous substrate.

14. The method of claim 13, wherein the porous substrate comprises a major surface and a plurality of macro pores coupled to the major surface; wherein a first portion of the composition is disposed on at least a portion of the major surface; and wherein at least a portion of the plurality of macro pores are impregnated with a second portion of the composition.

15. The method of claim 13, wherein drying the hydrated composition to form the composition disposed on the porous substrate further comprises exposing the hydrated composition to an elevated temperature, applying a vacuum to the hydrated composition, or both.

16. The method of claim 13, wherein the plurality of PTFE fibrils comprises long-strand PTFE fibrils and short-strand PTFE fibrils and the PTFE resin comprises long-strand PTFE resin and short-strand PTFE resin.

17. A method for disposing a composition on a porous substrate,
the composition comprising a matrix comprising a plurality of PTFE fibrils formed from PTFE resin; and a plurality of active particles;
the method comprising:
i) optionally forming a matrix pre-mixture, the matrix pre-mixture comprising:
PTFE resin; and
a surfactant;
ii) optionally aerating the matrix pre-mixture to form an aerated matrix pre-mixture, the aerated matrix pre-mixture comprising the matrix pre-mixture;
iii) contacting at least a portion of a porous substrate with a matrix pre-mixture or an aerated matrix pre-mixture;
iv) contacting the at least a portion of the substrate with a solid particulate composition, the solid particulate composition comprising a solid particulate;
v) allowing a hydrated composition to be disposed on the at least a portion of the porous substrate; the hydrated composition comprising:
the matrix;
at least a portion of the dispersant; and
at least a portion of the surfactant;
the plurality of active particles comprising at least a portion of the solid particulate; and
vi) drying the hydrated composition to form the composition disposed on the porous substrate.

18. The method of claim 17, wherein the porous substrate comprises a major surface and a plurality of macro pores coupled to the major surface; wherein a first portion of the composition is disposed on at least a portion of the major surface; and wherein at least a portion of the plurality of macro pores are impregnated with a second portion of the composition.

19. The method of claim 18, wherein the composition further comprises free active particles, free PTFE fibrils, or both and the solid particulate comprises at least a portion of the free active particles.

20. The method of claim 19, wherein the porous substrate comprises at least one free PTFE fibril of the free PTFE fibrils, at least one free active particle of the free active particles, at least a portion of the composition, or any combination thereof embedded within the porous substrate.
